(19) United States
(12) Patent Application Publication
(10) Pub. No.: US 2013/0151617 A1
(43) Pub. Date: Jun. 13, 2013

(54) BEHAVIORAL FINGERPRINTING VIA SOCIAL NETWORK VERIFICATION

(71) Applicant: Elwha LLC, a limited liability corporation of the, Bellevue, WA (US)

(72) Inventors: Marc E. Davis, San Francisco, CA (US); Matthew G. Dyor, Bellevue, WA (US); Daniel A. Gerrity, Seattle, WA (US); Xuedong Huang, Bellevue, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Nathan P. Myhrvold, Bellevue, WA (US); Clarence T. Tegreene, Mercer Island, WA (US)

(73) Assignee: Elwha LLC, a limited liability corporation of the State of Delaware, Bellevue, WA (US)

(21) Appl. No.: 13/673,506

(22) Filed: Nov. 9, 2012

Related U.S. Application Data
(63) Continuation-in-part of application No. 13/665,841, filed on Oct. 31, 2012.
Application No. 13/665,841 is a continuation-in-part of application No. 13/665,830, filed on Oct. 31, 2012.
Application No. 13/665,830 is a continuation-in-part of application No. 13/631,667, filed on Sep. 28, 2012.
Application No. 13/631,667 is a continuation-in-part of application No. 13/602,061, filed on Aug. 31, 2012.
Application No. 13/602,061 is a continuation-in-part of application No. 13/563,599, filed on Jul. 31, 2012.
Application No. 13/563,599 is a continuation-in-part of application No. 13/552,502, filed on Jul. 18, 2012.
Application No. 13/552,502 is a continuation-in-part of application No. 13/538,385, filed on Jun. 29, 2012.
Application No. 13/538,385 is a continuation-in-part of application No. 13/475,564, filed on May 18, 2012.
Application No. 13/475,564 is a continuation-in-part of application No. 13/373,682, filed on Nov. 23, 2011.
Application No. 13/373,682 is a continuation-in-part of application No. 13/373,677, filed on Nov. 23, 2011.
Application No. 13/373,677 is a continuation-in-part of application No. 13/373,680, filed on Nov. 23, 2011.
Application No. 13/373,680 is a continuation-in-part of application No. 13/373,684, filed on Nov. 23, 2011.
Application No. 13/373,684 is a continuation-in-part of application No. 13/373,685, filed on Nov. 23, 2011.
(60) Provisional application No. 61/572,309, filed on Oct. 13, 2011.

(51) Int. Cl. H04L 29/08

(52) U.S. Cl. CPC H04L 67/02
USPC 709/204

(57) ABSTRACT

Disclosed herein are example embodiments for behavioral fingerprinting via social network verification. For certain example embodiments, one or more devices may (i) detect at least one attempt to perform at least one task via at least one user device; and (ii) initiate transmission of at least one verification inquiry to one or more social network connections based at least partly on the at least one attempt to perform the at least one task via the at least one user device. However, claimed subject matter is not limited to any particular described embodiments, implementations, examples, or so forth.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

(1) For purposes of the USPTO extra-statutory requirements, the present application claims benefit of priority of U.S. Provisional Patent Application No. 61/632,836, entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 24 Sep. 2011 (with Atty. Docket No. SE1-0540-US), which was filed within the twelve months preceding the filing date of the present application or is an application of which a currently co-pending application is entitled to the benefit of the filing date.

(2) For purposes of the USPTO extra-statutory requirements, the present application claims benefit of priority of U.S. Provisional Patent Application No. 61/572,309, entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 3.3 Oct. 2011 (with Atty. Docket No. SE1-0541-US), which was filed within the twelve months preceding the filing date of the present application or is an application of which a currently co-pending application is entitled to the benefit of the filing date.

(3) For purposes of the USPTO extra-statutory requirements, the present application constitutes a continuation-in-part of U.S. patent application Ser. No. 13/373,685, entitled “Behavioral Fingerprint Device Identification”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0542-US), which is currently co-pending or is an application of which a currently co-pending application is entitled to the benefit of the filing date.

(4) For purposes of the USPTO extra-statutory requirements, the present application constitutes a continuation-in-part of U.S. patent application Ser. No. 13/373,684, entitled “Behavioral Fingerprint Controlled Automatic Task Determination”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0543-US), which is currently co-pending or is an application of which a currently co-pending application is entitled to the benefit of the filing date.

(5) For purposes of the USPTO extra-statutory requirements, the present application constitutes a continuation-in-part of U.S. patent application Ser. No. 13/373,680, entitled “Behavioral Fingerprint Controlled Theft Detection and Recovery”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0544-US), which is currently co-pending or is an application of which a currently co-pending application is entitled to the benefit of the filing date.

(6) For purposes of the USPTO extra-statutory requirements, the present application constitutes a continuation-in-part of U.S. patent application Ser. No. 13/373,677, entitled “Trust Verification Schema Based Transaction Authorization”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0545-US), which is currently co-pending or is an application of which a currently co-pending application is entitled to the benefit of the filing date.

(7) For purposes of the USPTO extra-statutory requirements, the present application constitutes a continuation-in-part of U.S. patent application Ser. No. 13/373,682, entitled “Social Network Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0546-US), which is currently co-pending or is an application of which a currently co-pending application is entitled to the benefit of the filing date.

(8) For purposes of the USPTO extra-statutory requirements, the present application constitutes a continuation-in-part of U.S. patent application Ser. No. 13/475,564, entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 May 2012 (with Atty. Docket No. SE1-0547-US), which is currently co-pending or is an application of which a currently co-pending application is entitled to the benefit of the filing date.

(9) For purposes of the USPTO extra-statutory requirements, the present application constitutes a continuation-in-part of U.S. patent application Ser. No. 13/538,385, entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 29 Jun. 2012 (with Atty. Docket No. SE1-0548-US), which is currently co-pending or is an application of which a currently co-pending application is entitled to the benefit of the filing date.

(10) For purposes of the USPTO extra-statutory requirements, the present application constitutes a continuation-in-part of U.S. patent application Ser. No. 13/552,502, entitled “Relationship Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 Jul. 2012 (with Atty. Docket No. SE1-0549-US), which is currently co-pending or is an application of which a currently co-pending application is entitled to the benefit of the filing date.

(11) For purposes of the USPTO extra-statutory requirements, the present application constitutes a continuation-in-part of U.S. patent application Ser. No. 13/563,599, entitled “Multi-Device Behavioral Fingerprinting”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Jul. 2012 (with Atty. Docket No. SE1-0636-US), which is currently co-pending or is an application of which a currently co-pending application is entitled to the benefit of the filing date.

(12) For purposes of the USPTO extra-statutory requirements, the present application constitutes a continuation-in-part of U.S. patent application Ser. No. 13/602,061, entitled “Behavioral Fingerprinting Via Social Networking Interaction”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Aug. 2012 (with Atty. Docket No. SE1-0637-US), which is currently co-pending or is an application of which a currently co-pending application is entitled to the benefit of the filing date.

(13) For purposes of the USPTO extra-statutory requirements, the present application constitutes a continuation-in-part of U.S. patent application Ser. No. 13/631,667, entitled “Behavioral Fingerprinting Via Derived Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 28 Sep. 2012 (with Atty. Docket No. SE1-0638-US), which is currently co-pending or is an application of which a currently co-pending application is entitled to the benefit of the filing date.

(14) For purposes of the USPTO extra-statutory requirements, the present application constitutes a continuation-in-part of U.S. patent application Ser. No. 13/665,830, entitled “Behavioral Fingerprinting Via Inferred Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Oct. 2012 (with Atty. Docket No. SE1-0639-US), which is currently co-pending or is an application of which a currently co-pending application is entitled to the benefit of the filing date.

(15) For purposes of the USPTO extra-statutory requirements, the present application constitutes a continuation-in-part of U.S. patent application Ser. No. 13/665,841, entitled “Behavioral Fingerprinting Via Corroborative User Device”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Oct. 2012 (with Atty. Docket No. SE1-0640-US), which is currently co-pending or is an application of which a currently co-pending application is entitled to the benefit of the filing date.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BRIEF DESCRIPTION OF THE FIGURES

FIG. 1 is a schematic diagram of a user device, a server device, and at least one behavioral fingerprint, any of which may be involved individually or jointly in example authentication scenarios in accordance with certain example embodiments.

FIG. 2A is a schematic diagram of multiple user devices, multiple server devices, and at least one behavioral fingerprint, any of which may be involved individually or jointly in example authentication scenarios in accordance with certain example embodiments.

FIG. 2B is a schematic diagram of multiple user devices, multiple server devices, and multiple example locations for at least a portion of at least one behavioral fingerprint in accordance with certain example embodiments.

FIG. 3 is a schematic diagram illustrating an example behavioral fingerprint including one or more example indicators of one or more behavior-related acts in accordance with certain example embodiments.

FIG. 4 is a schematic diagram of an example user device including one or more example components in accordance with certain example embodiments.

FIG. 5 is a schematic diagram of an example server device including one or more example components in accordance with certain example embodiments.

FIGS. 6A and 6B are schematic diagrams of an example user device and an example server device, respectively, that have one or more functional modules in accordance with certain example embodiments.

FIG. 7A is a schematic diagram that includes at least one example device that is capable of handling scenarios for behavioral fingerprinting via social network verification in accordance with certain example embodiments.

FIGS. 7B-7C are schematic diagrams that include at least one example device and that depict example scenarios for implementing behavioral fingerprinting via social network verification in accordance with certain example embodiments.

FIG. 8A is a flow diagram illustrating an example method for at least one device with regard to behavioral fingerprinting via social network verification in accordance with certain example embodiments.

FIGS. 8B-8D depict example additions or alternatives for a flow diagram of FIG. 8A in accordance with certain example embodiments.

FIGS. 9A-9F depict example additions or alternatives for a flow diagram of FIG. 8A in accordance with certain example embodiments.

FIGS. 10A-10C depict example additions or alternatives for a flow diagram of FIG. 8A in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

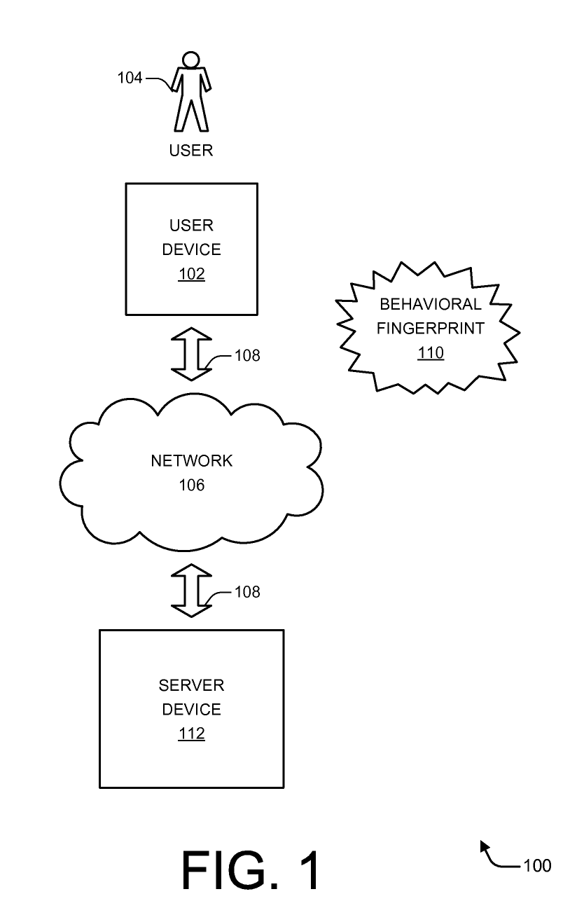

FIG. 1 is a schematic diagram 100 of a user device, a server device, and at least one behavioral fingerprint, any of which may be involved individually or jointly in example authentication scenarios in accordance with certain example embodiments. As shown in FIG. 1, by way of example but not limitation, schematic diagram 100 may include at least one user device 102, at least one user 104, at least one network 106, at least one channel 108, at least one behavioral fingerprint 110, or at least one server device 112. More specifically, at least one channel 108 may extend from or lead to a device 102 or 112 to facilitate communication therewith.

For certain example embodiments, a user 104 may correspond to or be utilizing at least one user device 102. A user 104 may utilize a user device 102 in accordance with a usage that may be at least partially represented by, modeled by, incorporated into, stored at, tracked by, summarized in, or a combination thereof, etc. at least one behavioral fingerprint 110. A user device 102 may include or comprise, by way of example but not limitation, a mobile phone, a smart phone, a mobile terminal, a laptop or notebook computer, a personal digital assistant (PDA), a netbook, an entertainment appliance (e.g., a television, a gaming console, a set-top box, a music player, or a combination thereof, etc.), a portable gaming device, a user equipment, a tablet or slate computer, a desktop computer, a personal navigation device (PND), a vehicle with user-accessible computational capabilities, videoconferencing equipment, some combination thereof, or so forth. A user 104 may include or comprise, by way of example only, at least one person, a couple, siblings, a family, a partnership, an organizational group, a company, a robotic user (e.g., a computational entity), an electronic agent, a portion thereof, some combination thereof, or so forth. However, claimed subject matter is not limited to any particular described embodiments, implementations, examples, etc.

For certain example embodiments, a network 106 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof, or so forth. A node may include, by way of example but not limitation, a server; a router; an end user device, such as a mobile phone, a tablet computer, a desktop computer, an entertainment appliance, a vehicle, or a combination thereof, etc.; a switch; a base station; a gateway; some combination thereof; or so forth. However, claimed subject matter is not limited to any particular described embodiments, implementations, examples, etc.

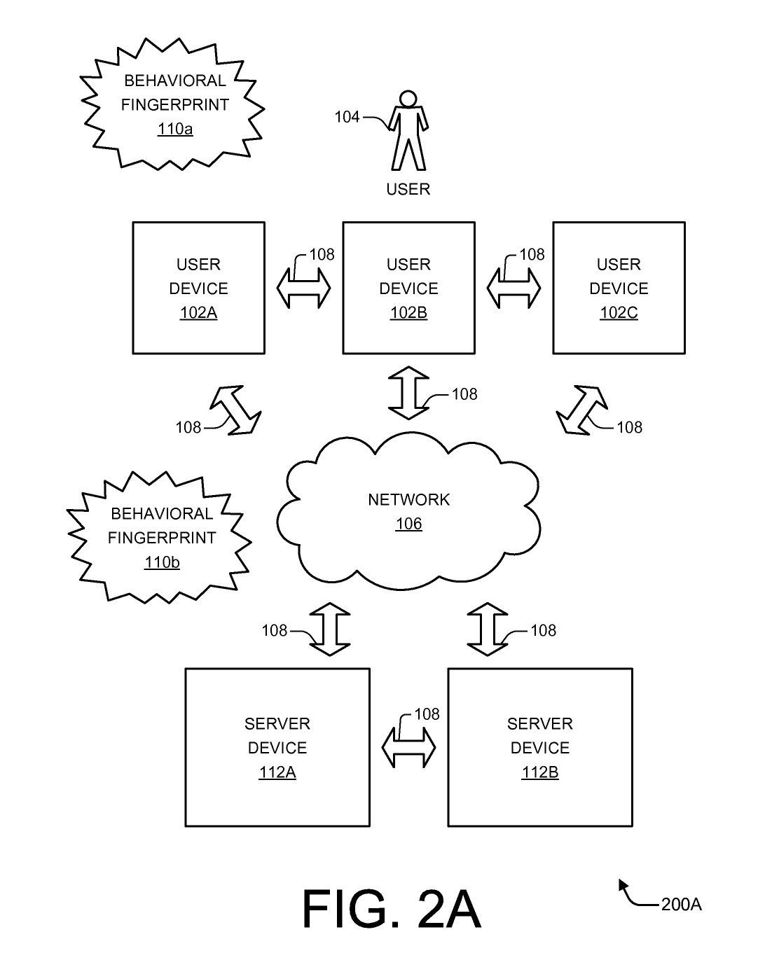

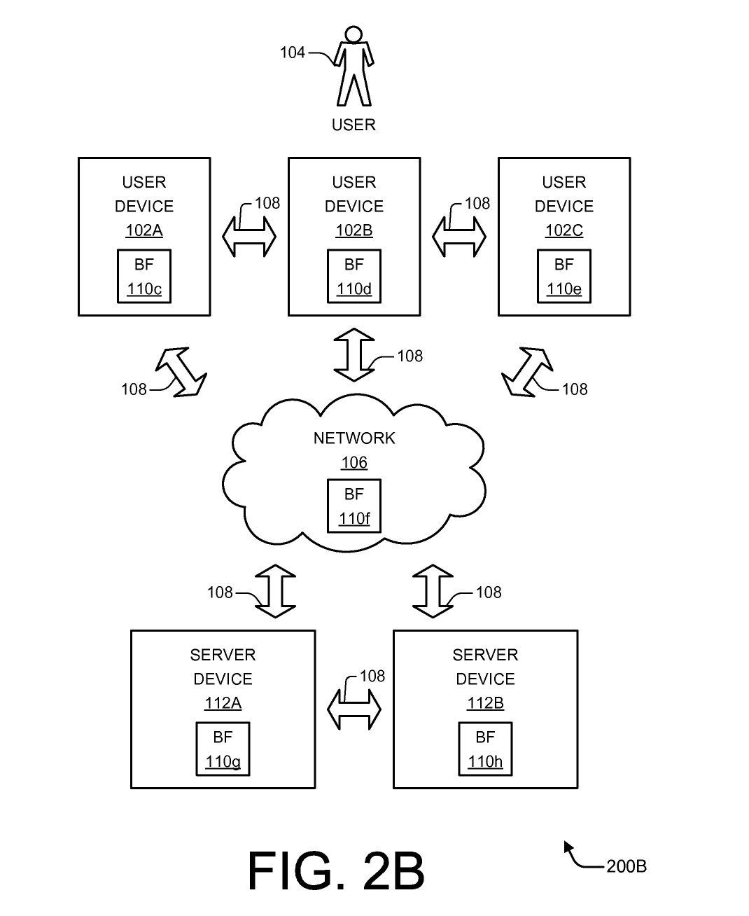

For certain example embodiments, a channel 108 may include, by way of example but not limitation, one or more of: at least one wired link, at least one wireless link, at least part of public network, at least part of a private network, at least part of a packet-switched network, at least part of a circuit-switched network, at least part of an infrastructure network, at least part of an ad hoc network, at least part of a PSTN, at least part of a cable network, at least part of a cellular network connection, at least part of an Internet connection, at least part of a Wi-Fi connection, at least part of a WiMax connection, at least part of an internet backbone, at least part of a satellite network, at least part of a fiber optic network, multiple instances of any of the above, one or more network nodes, some combination of the above, or so forth. A channel 108 may include one or more nodes (e.g., a telecommunication node, an access point, a base station, an internet server, a gateway, an internet or telecommunications switch, or a combination thereof, etc.) through which signals are propagated. A communication may include, by way of example but not limitation, a transmission of data, a reception of data, an exchange of data, a flow of data (e.g., between or among two or more intermediate nodes or endpoints), some combination thereof, or so forth. A user device 102 may communicate with a server device 112, or vice versa, via one or more signals (not explicitly shown) using one or more channels 108. A couple of examples of channels 108 are illustrated in schematic diagram 100 (as well as in additional figures, such as schematic diagram 200A of FIG. 2A). Signals may propagate via one or more channels 108. Signals, by way of example but not limitation, may include, electrical signals, magnetic signals, electromagnetic signals, photonic signals, wireless signals, wired signals, multiples ones thereof, some combination thereof, or so forth. However, claimed subject matter is not limited to any particular described embodiments, implementations, examples, etc.

For certain example embodiments, a server device 112 may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, or so forth. However, claimed subject matter is not limited to any particular described embodiments, implementations, examples, etc.

For certain example embodiments, at least one behavioral fingerprint 110 may include, by way of example but not limitation, one or more indicators representing one or more behaviors of at least one user with respect to at least one user device. Examples of one or more indicators representing one or more behaviors of at least one user with respect to at least one user device may include, but are not limited to, one or more indicators representing one or more habits of at least one user with respect to at least one user device, one or more indicators representing usage of at least one user device by at least one user, one or more indicators representing one or more actions of at least one user with respect to at least one user device, some combination thereof, or so forth. Additionally or alternatively, at least one behavioral fingerprint 110 may include, by way of example but not limitation, one or more indicators representing one or more predicted acts (e.g., behaviors, such as habits, usages, actions, or a combination thereof, etc.) of at least one user with respect to at least one device. Additionally or alternatively, at least one behavioral fingerprint 110 may include, by way of example but not limitation, at least one status of a user that is utilizing or that corresponds to a user device. For certain example implementations, a user whose behavior is being monitored to at least partially establish at least a portion of at least one behavioral fingerprint 110 may comprise an authorized user, which is described herein below. However, claimed subject matter is not limited to any particular described embodiments, implementations, examples, etc.

For certain example embodiments, a user may be utilizing a user device, by way of example but not limitation, if the user is accessing the user device, if the user is interacting with the user device, if the user is carrying the user device, if the user is providing input to the user device, if the user is receiving output from the user device, if the user is directing operation of the user device, some combination thereof, or so forth. A user may correspond to a user device, by way of example but not limitation, if the user is an authorized user of the user device. However, claimed subject matter is not limited to any particular described embodiments, implementations, examples, etc.

For certain example embodiments, a user 104 of a user device 102 may comprise an authorized user of the user device 102: if the user 104 comprises, by way of example but not limitation, a true owner, a manager, an information technology (IT) specialist, a controller, a purchaser, a lessee, an approved borrower, a primary user, or a combination thereof, etc. of the user device 102; if the user 104 is or has been authorized by a true owner, a manager, an IT specialist, a controller, a purchaser, a lessee, an approved borrower, a primary user, or a combination thereof, etc. of the user device 102; some combination thereof; or so forth. In certain example implementations, a determination that a user 104 comprises (e.g., is, is becoming, is being designated, or a combination thereof, etc.) an authorized user of a user device 102: may be effectuated if or when a user first registers a profile, an account, or a combination thereof, etc. on a device (e.g., after a purchase or a ‘hard’ reset); may be effectuated if or when one or more ‘sign-ins’ (e.g., entry of a password, code, PIN, pattern, biometric input, or a combination thereof, etc.) are performed by a user; may be effectuated if or when one or more user ID/secret information combinations (e.g., entry of an account name, email address, individualized identification, or a combination thereof, etc. along with a corresponding password, code, PIN, pattern, biometric input, or a combination thereof, etc.) are entered by a user; may be effectuated if or when a given user is identified as, designated as, or otherwise indicated to comprise an authorized user by one who is already an authorized user; some combination of such authorized user determinations; or so forth. An authorized user may add a new authorized user, by way of example only: by providing a name or other identification of another user or his or her biometric information (e.g., a facial photo, a voice sample, a fingerprint image, a retinal scan, or a combination thereof, etc.); by providing a name or other identification of a user or temporary or permanent secret information, such as a password, a code, a PIN, a pattern, biometric input, or a combination thereof, etc. (e.g., that a newly authorized user may be capable of changing or confirming); some combination thereof; or so forth. An authorized user, such as a true owner or IT specialist, may be empowered to remove someone from a list of authorized user(s). In certain example embodiments, different authorized users may have different levels of authorization (e.g., different levels of access, capabilities, rights, privileges, or a combination thereof, etc.) with respect to a given user device 102. For certain example implementations, but by way of example only, one authorized user may comprise an administrator with full access rights or privileges, yet another authorized user may comprise a regular, non-administrative, or junior user with fewer access rights or privileges. Additionally or alternatively, one authorized user may have full access rights to applications and content stored on a device or associated with a particular account/profile, yet another authorized user may have restricted access rights to applications or content stored on a device such that access is prevented, for instance, to particular device settings or adult content. Other approaches to providing different levels of authorization may also or instead be implemented. By way of example only, an authorized user who is a true owner may add a new authorized user that is permitted to utilize existing applications and content but is prohibited from adding new applications or making particular purchases (e.g., individual purchases above a predetermined dollar amount or multiple purchases beyond a total dollar amount).

FIG. 2A is a schematic diagram 200A of multiple user devices, multiple server devices, and at least one behavioral fingerprint, any of which may be involved individually or jointly in example authentication scenarios in accordance with certain example embodiments. As shown in FIG. 2A, by way of example but not limitation, schematic diagram 200A may include at least one user device 102, at least one user 104, at least one network 106, at least one channel 108, at least one behavioral fingerprint 110, or at least one server device 112. More specifically, schematic diagram 200A may include, by way of example only, three user devices 102 (e.g., a user device 102A, a user device 102B, or a user device 102C, etc.), two server devices 112 (e.g., a server device 112A, or a server device 112B, etc.), or two behavioral fingerprints 110 (e.g., a behavioral fingerprint 110a, or a behavioral fingerprint 110b, etc.).

For certain example embodiments, a user 104 may correspond to or be utilizing multiple user devices 102, such as at least two of user device 102A, user device 102B, or user device 102C, at least partially simultaneously or from time to time. By way of example only, a user 104 may own at least two of: a mobile phone, a tablet computer, a vehicle with an intelligent computing apparatus, a laptop computer, or a desktop computer. For certain example implementations, at least part of a combined behavioral fingerprint 110 (e.g., a behavioral fingerprint 110a/110b) may be associated with a user 104 and each corresponding user device 102. Additionally or alternatively, an individualized behavioral fingerprint 110 (e.g., a behavioral fingerprint 110a or a behavioral fingerprint 110b) may be associated with a user 104 and each corresponding individual or respective user device 102. However, claimed subject matter is not limited to any particular described embodiments, implementations, examples, etc.

For certain example embodiments, a behavioral fingerprint 110, 110a, or 110b; an at least partially combined instantiation of at least two of a behavioral fingerprint 110, 110a, or 110b; a portion of a behavioral fingerprint 110, 110a, or 110b; or a combination thereof; etc. may be distributed across or stored at, by way of example only, one or more of: a user device 102A, a user device 102B, a user device 102C, a network 106 or node thereof, a server device 112A, a server device 112B, some combination thereof, or so forth. Additionally or alternatively, a behavioral fingerprint 110, 110a, or 110b; an at least partially combined instantiation of at least two of a behavioral fingerprint 110, 110a, or 110b; a portion of a behavioral fingerprint 110, 110a, or 110b; or a combination thereof; etc. may be transmitted, received, exchanged, or a combination thereof, etc., by way of example only, via one or more of: at least one network 106, one or more channels 108, some combination thereof, or so forth. A user device 102 or a server device 112 may transmit, receive, exchange, or a combination thereof, etc. at least a portion of a behavioral fingerprint 110, 110a, or 110b directly between or among devices 102 or 112 or indirectly via at least one node (not explicitly shown) of one or more networks 106. However, claimed subject matter is not limited to any particular described embodiments, implementations, examples, etc.

FIG. 2B is a schematic diagram 200B of multiple user devices, multiple server devices, and multiple example locations for at least a portion of at least one behavioral fingerprint in accordance with certain example embodiments. As shown in FIG. 2B, by way of example but not limitation, schematic diagram 200B may include at least one user device 102, at least one user 104, at least one network 106, at least one channel 108, at least one behavioral fingerprint 110, or at least one server device 112. More specifically, schematic diagram 200B may include, by way of example only, three user devices 102 (e.g., a user device 102A, a user device 102B, or a user device 102C, etc.), two server devices 112 (e.g., a server device 112A, or a server device 112B, etc.), or six behavioral fingerprints 110 (e.g., a behavioral fingerprint 110c, a behavioral fingerprint 110d, a behavioral fingerprint 110e, a behavioral fingerprint 110f, a behavioral fingerprint 110g, or a behavioral fingerprint 110h, etc.).

For certain example embodiments, a given behavioral fingerprint 110 or portion thereof may be located at (stored at, distributed at least partially across, accessible from, associated with, or a combination thereof, etc.) one or more devices 102 or 112. By way of example only, a behavioral fingerprint 110c may be located at a user device 102A, a behavioral fingerprint 110d may be located at a user device 102B, a behavioral fingerprint 110e may be located at a user device 102C, a behavioral fingerprint 110f may be located at a network 106 (e.g., at a cloud service or system), a behavioral fingerprint 110g may be located at a server device 112A, or a behavioral fingerprint 110h may be located at a server device 1128. For certain example implementations, any one or more of behavioral fingerprints 110c-110h may include one or more separate or individualized behavioral fingerprints 110; may include one or more combined, amalgamated, distributed, or a combination thereof, etc. behavioral fingerprints 110; may include at least a portion of at least one behavioral fingerprint 110; some combination thereof; or so forth. However, claimed subject matter is not limited to any particular described embodiments, implementations, examples, etc.

For certain example embodiments, at least one behavioral fingerprint 110 (e.g., of behavioral fingerprints 110c-110h) may be associated with at least one user 104 or one or more of user devices 102A, 1028, or 102C. For certain example implementations, a behavioral fingerprint 110c, which may be stored at a user device 102A, may be associated with a user 104 and user device 102A. For certain example implementations, a behavioral fingerprint 110g, which may be stored at a server device 112A, may be associated with a user 104 and a user device 102A. For certain example implementations, a behavioral fingerprint 110h, which may be stored at a server device 1128, may be associated with a user 104, a user device 1028, and a user device 102C. For certain example implementations, a behavioral fingerprint 110c, which may be stored at a user device 102A and associated therewith, and a behavioral fingerprint 110d, which may be stored at a user device 1028 and associated therewith, may be individually or jointly associated with a user 104. A behavioral fingerprint 110c and a behavioral fingerprint 110d may be identical to each other, partially the same, different from one another, updated to keep one at least partially coherent or consistent with the other, some combination thereof, or so forth. For certain example implementations, a behavioral fingerprint 110d, which may be stored at a user device 1028 and associated therewith, and a behavioral fingerprint 110g, which may be stored at a server device 112A and associated with a user device 102C, may be individually or jointly associated with a user 104. A behavioral fingerprint 110d and a behavioral fingerprint 110g may be identical to each other, partially the same, different from one another, updated to keep one at least partially coherent or consistent with the other, some combination thereof, or so forth. For certain example implementations, a behavioral fingerprint 110e, which may be stored at a user device 102C and associated therewith, and a behavioral fingerprint 110h, which may be stored at a server device 112B and also associated with user device 102C, may be individually or jointly associated with a user 104. A behavioral fingerprint 110e and a behavioral fingerprint 110h may be identical to each other, partially the same, different from one another, updated to keep one at least partially coherent or consistent with the other, some combination thereof, or so forth. For certain example implementations, a behavioral fingerprint 110e, which may be stored at a user device 102C, may be associated with a user 104 and a user device 1026. Although each user device 102 and server device 112 (and network 106) is shown in schematic diagram 200B as having a behavioral fingerprint 110 located there at, one or more user devices 102 or server devices 112 (or networks 106) may alternatively not have a behavioral fingerprint 110 located there at. Furthermore, other additional or alternative approaches may instead be implemented.

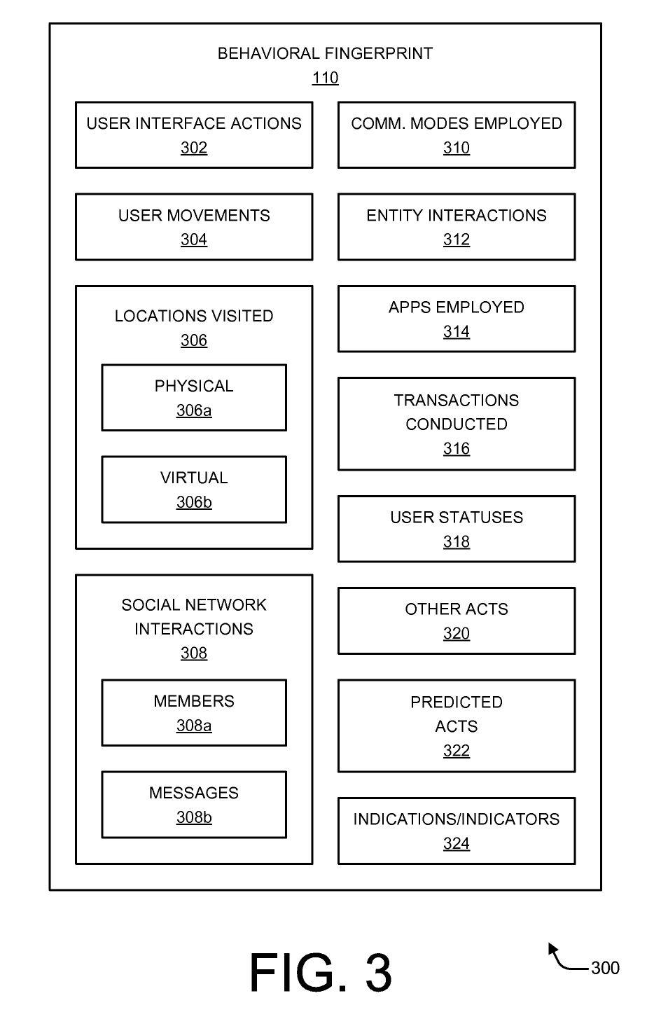

For certain example embodiments, a behavioral fingerprint 110 (including but not limited to any one or more of behavioral fingerprints 110a-110h) may include a whole behavioral fingerprint, a portion of a behavioral fingerprint, a behavioral fingerprint associated with a single user device, a behavioral fingerprint associated with multiple user devices, a part of a distributed behavioral fingerprint, a whole behavioral fingerprint that is distributed across multiple devices, a portion or a whole behavioral fingerprint that is located at one device, one or more indicators of one or more behavior-related acts, some combination thereof, or so forth. Examples of behavioral fingerprint(s) 110 are described further herein below with particular reference to FIG. 3. However, claimed subject matter is not limited to any particular described embodiments, implementations, examples, etc.

FIG. 3 is a schematic diagram 300 illustrating an example behavioral fingerprint including one or more example indicators of one or more behavior-related acts in accordance with certain example embodiments. As shown in FIG. 3, by way of example but not limitation, schematic diagram 300 may depict a behavioral fingerprint 110, which behavioral fingerprint 110 may include any one or more of indications of various acts 302-322 or other indications 324. Example indications 302-324 that are illustrated may include, but are not limited to, user interface actions 302, user movements 304, locations visited 306, social network interactions 308, communication modes employed 310, entity interactions 312, apps employed 314, transactions conducted 316, user statuses 318, other acts 320, predicted acts 322, other indications or indicators 324, some combination thereof, or so forth. More specifically, locations visited 306 may include physical locations visited 306a, virtual locations visited 306b, or a combination thereof, etc., or social network interactions 308 may include social network members 308a, social network messages 308b, or a combination thereof, etc. Additional or alternative implementations to those of schematic diagram 300 for a behavioral fingerprint 110 are described further herein below as well as above. Moreover, a behavioral fingerprint 110 may alternatively include more, fewer, or different indication(s) from those that are illustrated without departing from claimed subject matter.

For certain example embodiments, one or more user interface actions 302 may include, but are not limited to, a type of user interaction (e.g., buttons, keys, physical keyboard, touch screen, swipes, virtual buttons, virtual keyboard, multi-finger touch, speech, textual, movement sensing input such as a shake or a twist, or a combination thereof, etc.), a speed of user interaction (e.g., speech rate, speech cadence, typing speed, swiping speed, scrolling speed, speed moving between or among windows or apps, duration of a swipe or press of a virtual or physical key or button, or a combination thereof, etc.), a user input apparatus (e.g., a built-in microphone, a wireless microphone, a built-in keyboard, a virtual keyboard, a detachable/attachable keyboard, a wireless keyboard, an input apparatus identifiable such as by name or number, or a combination thereof, etc.), a position of user interaction (e.g., a location of touch for a touch-sensitive screen having a keyboard or button or swipe area, a location of a swipe, a length of a swipe, an offset from a designated key or slide area, or a combination thereof, etc.), a user output apparatus (e.g., a screen, a built-in speaker, a separate speaker, a vibration unit, an integrated output apparatus, a wired output apparatus, a wireless output apparatus, an output apparatus identifiable such as by name or number, or a combination thereof, etc.), some combination thereof, or so forth. However, claimed subject matter is not limited to any particular described embodiments, implementations, examples, etc.

For certain example embodiments, one or more user movements 304 may include, but are not limited to, device orientation (e.g., cardinal direction a device is pointed at, angle a device is held at, or a combination thereof, etc.), device shakes or deformations (e.g., how a device is moved to provide input, how a device is pressed or twisted or curved to provide input, or a combination thereof, etc.), a pattern of vibrations or jostling applied to or experienced by a device during daily use (e.g., as a result of carrying it, commuting with it, placing it in a pack or purse, placing it in a pocket, or a combination thereof, etc.), some combination thereof, or so forth. However, claimed subject matter is not limited to any particular described embodiments, implementations, examples, etc.

For certain example embodiments, one or more locations visited 306 may include, but are not limited to, locations that a user carries, sends, places, or travels with a device; locations that a user directs software to acquire data from or send data to; some combination thereof; or so forth. For certain example implementations, physical locations visited 306a may include, but are not limited to, an address, a room, a store, a building, a neighborhood, a city, a state, a country, one or more satellite positioning system (SPS) coordinates, a check-in location, a business, one or more geographical (e.g., cardinal) coordinates, a geographical zone (e.g., coordinates or approximate position in conjunction with a distance or range), some combination thereof, or so forth. For certain example implementations, virtual locations visited 306b may include, but are not limited to, an internet address, a web page, a web site, a social network, a destination within a social network, a virtual world, a destination within a virtual world, a chat room, a bulletin board, a blog, some combination thereof, or so forth. However, claimed subject matter is not limited to any particular described embodiments, implementations, examples, etc.

For certain example embodiments, one or more social network interactions 308 may include, but are not limited to, accessing a social network, reading a communication from one or more social network members, sending a communication to one or more social network members, changing profile or account information for a social network, viewing publicly-available social network information (e.g., viewing a person's wall, board, stream, pinning, or a combination thereof, etc.), viewing private social network information (e.g., viewing a targeted or personalized message, tweet, picture, or a combination thereof, etc.), searching for entities on a social network, playing games via a social network, experiencing entertainment (e.g., video, audio, clips, pictures, or a combination thereof, etc.) via a social network, a listing of which social network(s) are accessed, an order of which social networks are accessed, a day or time of accessing particular social network(s), some combination thereof, or so forth. For certain example implementations, social network member interactions 308a may include, but are not limited to, identifying or listing members interacted with via receiving, retrieving, sending, replying to or a combination thereof, etc. one or more communications; noting particular social network protocols or modes (e.g., wall writing or viewing, tweet sending or receiving, picture sending or viewing, public versus private communicating, or a combination thereof, etc.) used to communicate with particular members individually or in groups; noting particular social network protocols or modes used to communicate with particular member groups; some combination thereof; or so forth. For certain example implementations, social network message interactions 308b may include, but are not limited to, noting (e.g., recording, memorializing, storing, identifying, or a combination thereof, etc.) messages sent or received, noting an order of message sending or viewing, noting a type (e.g., a social network protocol) of message sent or received, noting a number of messages sent or received, noting a duration between arrival of a message (e.g., generally or from a particular member) and viewing of the message, noting a duration between arrival or viewing of a message (e.g., generally or from a particular member) and responding to the message, some combination thereof, or so forth. However, claimed subject matter is not limited to any particular described embodiments, implementations, examples, etc.

For certain example embodiments, one or more communication modes employed 310 may include, but are not limited to, speech, a phone call, a voice-over-internet-protocol (VoIP) communication, text messaging, instant messaging, a video communication (e.g., a video call, a video conference, or a combination thereof, etc.), a social-network-based communication (e.g., a communication that is effectuated at least partially using a social network app, web site, service, or a combination thereof, etc.), some combination thereof, or so forth. Additionally or alternatively, one or more communication modes employed 310 may include, but are not limited to, indications of which communication mode is employed if/when responding to a received communication of a given communication mode (e.g., it may be noted that an authorized user may respond to most phone calls or phone calls from particular people with text messages). However, claimed subject matter is not limited to any particular described embodiments, implementations, examples, etc.

For certain example embodiments, one or more entity interactions 312 may include, but are not limited to, identification of at least one entity (e.g., business, service, person, social network member, group, organization, or a combination thereof, etc.) that a user interacts with (e.g., with or without an indication of a communication mode, such as via a telephone capability, via email, via instant messaging, via a social network communication protocol, via VoIP, via a video capability, via a speech capability, or a combination thereof, etc.), a listing of entities interacted with, an order of entities interacted with, notations of when (e.g., a day, a time, days of week, or a combination thereof, etc.) entities are interacted with, notations of how (e.g., a communication mode used, a duration, or a combination thereof, etc.) entities are interacted with, some combination thereof, or so forth. However, claimed subject matter is not limited to any particular described embodiments, implementations, examples, etc.

For certain example embodiments, one or more apps employed 314 may include, but are not limited to, identification of one or more apps (e.g., applications, native applications, downloaded applications, installed applications, software applications, web applications, or a combination thereof, etc.) employed (e.g., accessed, started, opened, launched, viewed, consulted, manipulated, configured, installed, executed, or a combination thereof, etc.) by a user, a listing of apps employed, an order of apps employed, a notation of a time or a day at which apps are employed, a notation of duration(s) for which apps are employed, some combination thereof, or so forth. However, claimed subject matter is not limited to any particular described embodiments, implementations, examples, etc.

For certain example embodiments, one or more transactions conducted 316 may include, but are not limited to, an identification of transactions (e.g., exchanges of consideration, purchases, orders, downloads, or a combination thereof, etc.) conducted (e.g., initiated, requested, consummated, effectuated, accomplished, monitored, or a combination thereof, etc.), a list of transactions, a notation of times or days of transactions, a notation of transaction amounts, a notation of at least one party to one or more transactions, a notation of items (e.g., physical items such as food or electronics, virtual items such as songs or movies or games or in-game abilities, or a combination thereof, etc.) or services (e.g., physical services such as a massage or a car wash, virtual services such as streaming media or a membership, or a combination thereof, etc.) involved in one or more transactions, some combination thereof, or so forth. However, claimed subject matter is not limited to any particular described embodiments, implementations, examples, etc.

For certain example embodiments, one or more user statuses 318 may include, but are not limited to, a location status update, a health status update, an alert (e.g., as to whether a person has possession or has lost possession of a device; as to whether a device has exceeded some percentage—e.g. 50% or 75% or 100%—of an allotted amount, such as of minutes of talking, bytes of data, messages of texting, dollars of a fund, time of use, etc.; as to where a person is currently located; a combination thereof; etc.), a current (e.g., most recent, present, or a combination thereof, etc.) activity update, some combination thereof, or so forth. However, claimed subject matter is not limited to any particular described embodiments, implementations, examples, etc.

For certain example embodiments, one or more other acts 320 may include, but are not limited to, other user behaviors, user habits, user actions, user movements, user interactions, user visitations, user transactions, device features (e.g., capabilities, native applications, operating system functions, or a combination thereof, etc.) employed, or a combination thereof, etc. that a device may monitor (e.g., detect, observe, discern, ascertain, or a combination thereof, etc.); other acts reflecting user behavior; other acts described herein; some combination thereof; or so forth. However, claimed subject matter is not limited to any particular described embodiments, implementations, examples, etc.

For certain example embodiments, one or more predicted acts 322 may include, but are not limited to, an act that is predicted based at least partially on any one or more of other indications 302-320; an act that is predicted to be performed by an authorized user; an act corresponding to a particular likelihood level of re-occurring; an act that is predicted to re-occur in view of one or more observed acts of at least one authorized user of one or more user devices; an act that is predicted to occur based at least partially on a statistical analysis (e.g., a likelihood function, a histogram evaluation, a probabilistic approach, a Bayesian analysis, a stochastic mechanism, a correlation procedure, a probability density function, a normal/Gaussian distribution, a cumulative distribution function, an expected value, or a combination thereof, etc.) of one or more historically-monitored acts; an act that has been repeatedly performed in certain manner(s) or at particular time(s) such that it can be expected to be performed again in such certain manner(s) or at such particular time(s); an act that is derived or results from a conversion of monitored act(s) corresponding to one device to at least one act corresponding to another device; some combination thereof; or so forth. However, claimed subject matter is not limited to any particular described embodiments, implementations, examples, etc.

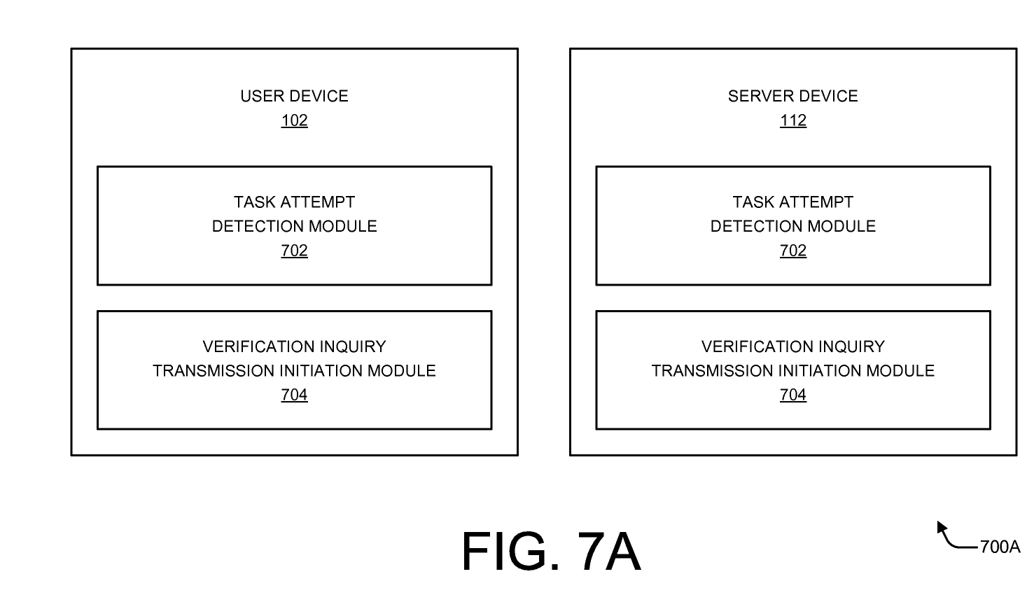

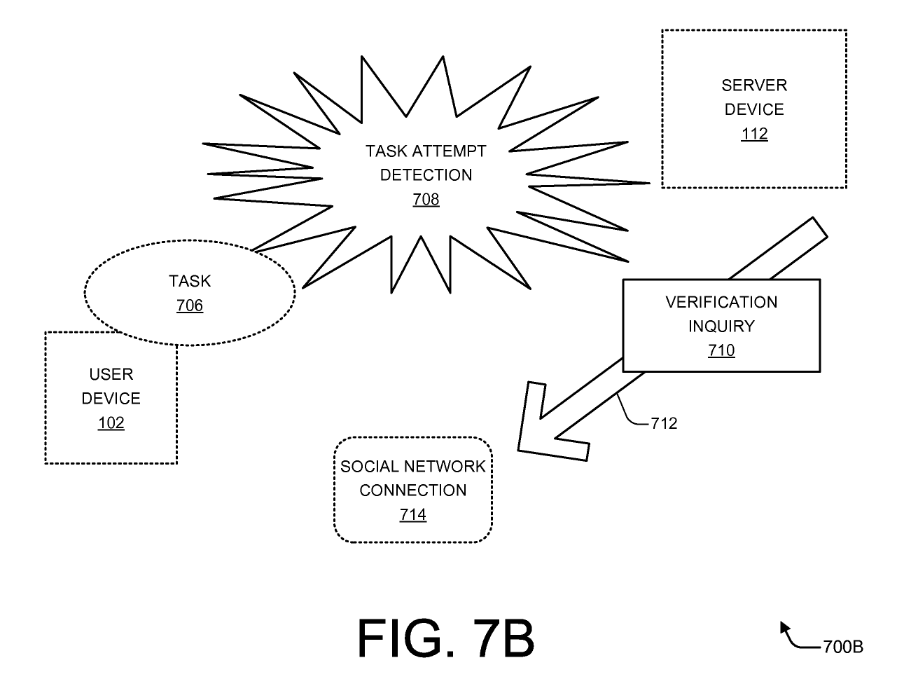

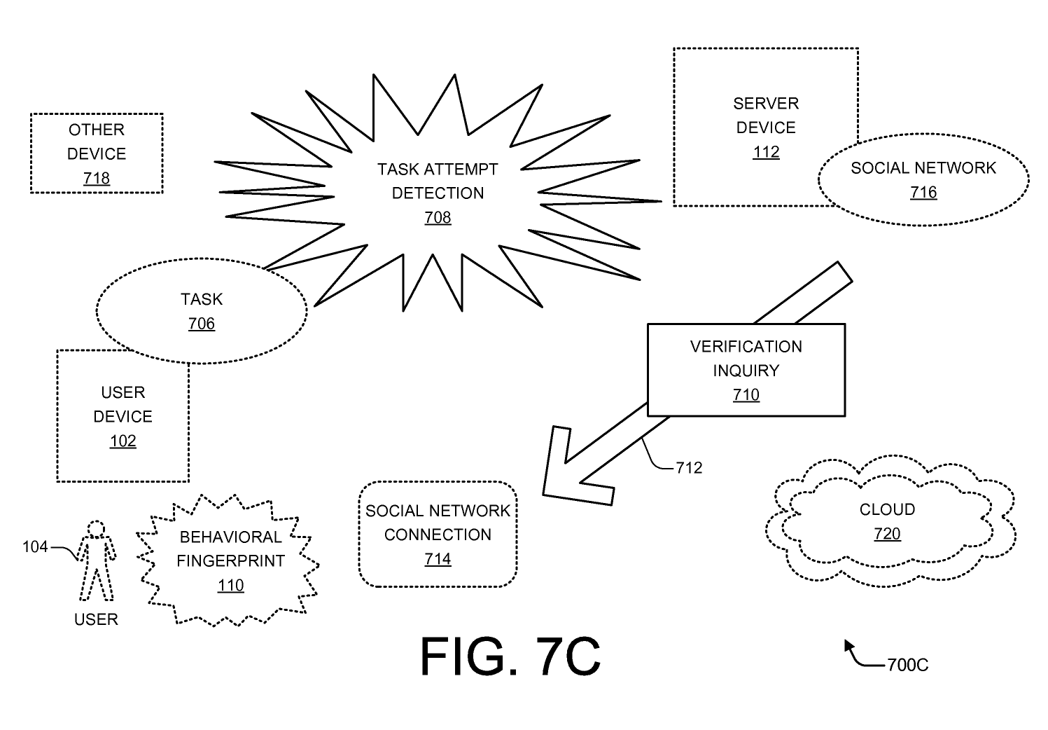

For certain example embodiments, one or more other indications 324 may include, but are not limited to, static characteristics of an authorized user, individuals that are related to an authorized user, characteristics of individuals that are related to an authorized user; nature of relationships between or among an authorized user and other individuals, some combination thereof, or so forth. Non-exhaustive examples of other indications or indicators 324 are provided herein below with particular reference to FIG. 7A-7C, 8A-8D, 9A-9F, or 10A-10C. However, claimed subject matter is not limited to any particular described embodiments, implementations, examples, etc.

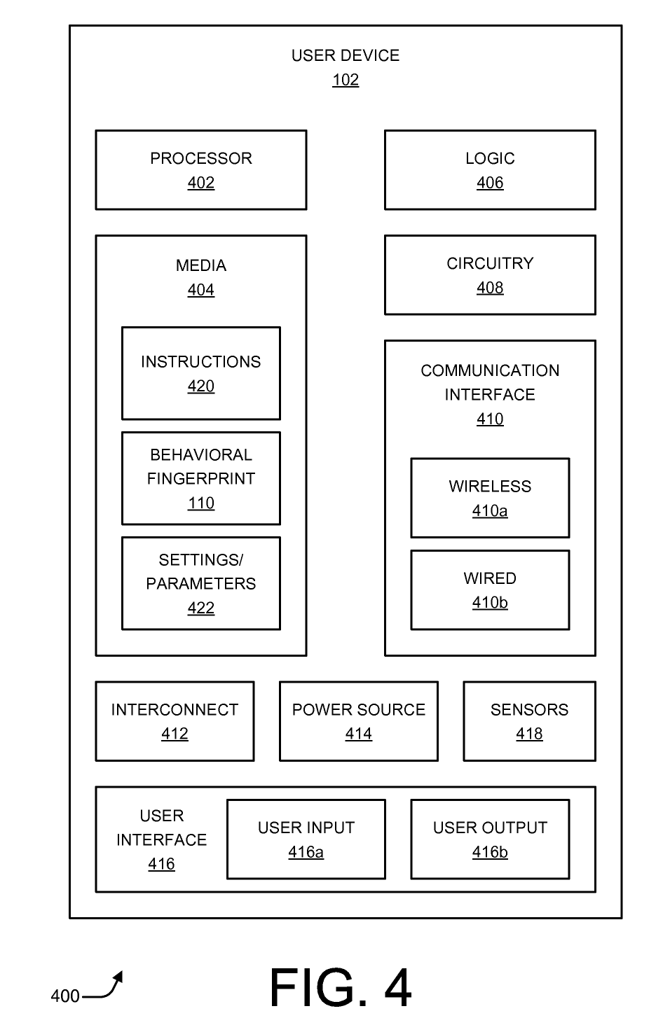

FIG. 4 is a schematic diagram 400 of an example user device including one or more example components in accordance with certain example embodiments. As shown in FIG. 4, a user device 102 may include one or more components such as: at least one processor 402, one or more media 404, logic 406, circuitry 408, at least one communication interface 410, at least one interconnect 412, at least one power source 414, at least one user interface 416, one or more sensors 418, some combination thereof, or so forth. Furthermore, as shown in schematic diagram 400, one or more media 404 may include one or more instructions 420, at least one behavioral fingerprint 110, one or more settings or parameters 422, some combination thereof, or so forth; a communication interface 410 may include at least one wireless communication interface 410a, at least one wired communication interface 410b, some combination thereof, or so forth; or a user interface 416 may include at least one user input interface 416a, at least one user output interface 416b, some combination thereof, or so forth. However, a user device 102 may alternatively include more, fewer, or different component(s) from those that are illustrated without departing from claimed subject matter.

For certain example embodiments, a user device 102 may include or comprise at least one electronic device. User device 102 may include, for example, a computing platform or any electronic device having at least one processor or memory. Processor 402 may include, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 404 may bear, store, contain, include, provide access to, or a combination thereof, etc. instructions 420, which may be executable by a processor 402; at least one behavioral fingerprint 110; one or more settings/parameters 422; some combination thereof; or so forth. Instructions 420 may include or comprise, by way of example but not limitation, a program, a module, an application or app (e.g., that is native, that runs in a browser, that runs within a virtual machine, or a combination thereof, etc.), an operating system, or a combination thereof, etc. or portion thereof; operational data structures; source code, object code, just-in-time (JIT) compiled code, or a combination thereof, etc.; processor-executable instructions; other code; some combination thereof; or so forth. Media 404 may include, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, or a combination thereof, etc.) that is capable of bearing instructions, a behavioral fingerprint, settings, parameters, some combination thereof, or so forth.

For certain example embodiments, execution of instructions 420 by one or more processors 402 may transform user device 102 into a special-purpose computing device, apparatus, platform, machine, some combination thereof, or so forth. Instructions 420 may include, for example, instructions that are capable of realizing at least a portion of one or more flow diagrams, methods, processes, procedures, operations, functionality, technology, mechanisms, or a combination thereof, etc. that are described herein or illustrated in the accompanying drawings. Settings/parameters 422 may include, by way of example but not limitation, one or more settings or parameters that may be established or determined by a user or other entity, one or more or settings or parameters that may be determined or detected by a user device 102, one or more settings or parameters that may be received from another device that determined or detected them, one or more settings or parameters that may determine at least partly how a user device 102 is to operate or respond to a situation or a behavioral fingerprint, one or more settings or parameters (e.g., values) that may be used to realize flow diagrams, methods, processes, procedures, operations, functionality, technology, mechanisms, or a combination thereof, etc. that are described herein or illustrated in the accompanying drawings. Settings/parameters 422 may control at least partially how at least one behavioral fingerprint 110 is configured, stored, shared, used, applied, some combination thereof, or so forth. Additionally or alternatively, at least a portion of settings/parameters 422 may be at least partially integrated with at least one behavioral fingerprint 110.

For certain example embodiments, logic 406 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings. Circuitry 408 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings, wherein circuitry 408 includes at least one physical or hardware component or aspect.

For certain example embodiments, one or more communication interfaces 410 may provide one or more interfaces between user device 102 and another device or a person/operator. With respect to a person/operator, a communication interface 410 may include, by way of example but not limitation, a screen, a speaker, a keyboard or keys, a microphone, or other person-device input/output apparatuses. A wireless communication interface 410a or a wired communication interface 410b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, or a combination thereof, etc.), a physical or logical network adapter or port, a frequency converter, a baseband processor, or a combination thereof, etc. to communicate wireless signals or wired signals via one or more wireless communication links or wired communication links, respectively, such as over at least one channel 108 (e.g., of FIGS. 1 and 2A). Communications with at least one communication interface 410 may enable transmitting, receiving, or initiating of transmissions, just to name a few examples.

For certain example embodiments, at least one interconnect 412 may enable signal communication between or among components of user device 102. Interconnect 412 may include, by way of example but not limitation, one or more buses, channels, switching fabrics, some combination thereof, or so forth. Although not explicitly illustrated in FIG. 4, one or more components of user device 102 may be coupled to interconnect 412 via a discrete or integrated interface. By way of example only, one or more interfaces may couple a communication interface 410 or a processor 402 to at least one interconnect 412. For certain example embodiments, at least one power source 414 may provide power to one or more components of user device 102. Power source 414 may include, by way of example but not limitation, a battery, a power connector, a solar power source or charger, a mechanical power source or charger, a fuel source, some combination thereof, or so forth.

For certain example embodiments, at least one sensor 418 may sense, produce, or otherwise provide at least one sensor value. Sensors 418 may include, by way of example only, a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), some combination thereof, or so forth. Values provided by at least one sensor 418 may include, by way of example but not limitation, an image, a sound recording, an acceleration value, a temperature, SPS coordinates, a barometric pressure, a humidity level, a compass direction, a gyroscopic value, a magnetic reading, a pressure value, an oscillation value, an ambient light reading, inertial readings, touch detections, finger placements, flex detections, some combination thereof, or so forth.

For certain example embodiments, a user interface 416 may enable one or more users to interact with user device 102. Interactions between a user and a user device may relate, by way of example but not limitation: to touch/tactile/feeling/haptic sensory (e.g., a user may shake, rotate, decline/incline, bend, twist, or move a user device which may be detected by a gyroscope, an accelerometer, a compass, or a combination thereof, etc.; a user may press a button, slide a switch, rotate a knob, etc.; a user may touch a touch-sensitive screen; a device may vibrate; some combination thereof; or so forth), to sound/hearing/speech sensory (e.g., a user may speak into a microphone, a device may generate sounds via a speaker, or a combination thereof, etc.), to sights/vision sensory (e.g., a device may activate one or more lights, modify an image presented on a display screen, or a combination thereof, etc.), some combination thereof, or so forth.

For certain example embodiments, a user interface 416 may include a user input interface 416a, a user output interface 416b, some combination thereof, or so forth. A user input interface 416a may include, by way of example but not limitation, a microphone, a button, a switch, a dial, a knob, a wheel, a trackball, a key, a keypad, a keyboard, a touch-sensitive screen, a touch-sensitive surface, a camera, a gyroscope, an accelerometer, a compass, a virtual button/slider/keyboard/etc. presented on a touch-sensitive screen, some combination thereof, or so forth. A user output interface 416b may include, by way of example but not limitation, a speaker, a screen (e.g., with or without touch-sensitivity), a vibrating haptic feature, some combination thereof, or so forth. Certain user interfaces 416 may enable both user input and user output. For example, a touch-sensitive screen may be capable of providing user output and accepting user input. Additionally or alternatively, a user interface 416 component (e.g., that may be integrated with or separate from a user device 102), such as a headset that has a microphone and a speaker, may enable both user input and user output.

However, claimed subject matter is not limited to any particular described embodiments, implementations, examples, or so forth. For instance, it should be understood that for certain example implementations components that are illustrated separately in FIG. 4 may not necessarily be separate or mutually exclusive. For example, a given component may provide multiple functionalities. By way of example only, a single component such as a USB connector may function as a wired communication interface 410b or a power source 414. Additionally or alternatively, a single component such as a display screen may function as a communication interface 410 with respect to a user, as a user input interface 416a, or as a user output interface 416b. Additionally or alternatively, one or more instructions 420 may function to realize at least part of a behavioral fingerprint 110 or at least one setting or parameter 422.

It should also be understood that for certain example implementations components that are illustrated in schematic diagram 400 or described herein may or may not be integral with or integrated into a user device 102. For example, a component may be removably connected to a user device 102, a component may be wirelessly coupled to a user device 102, some combination thereof, or so forth. By way of example only, instructions 420 may be stored on a removable card having at least one medium 404. Additionally or alternatively, a user interface 416 (e.g., a wired or wireless headset, a screen, a video camera, a keyboard, or a combination thereof, etc.) may be coupled to a user device 102 wirelessly or by wire. However, claimed subject matter is not limited to any particular described embodiments, implementations, examples, etc.

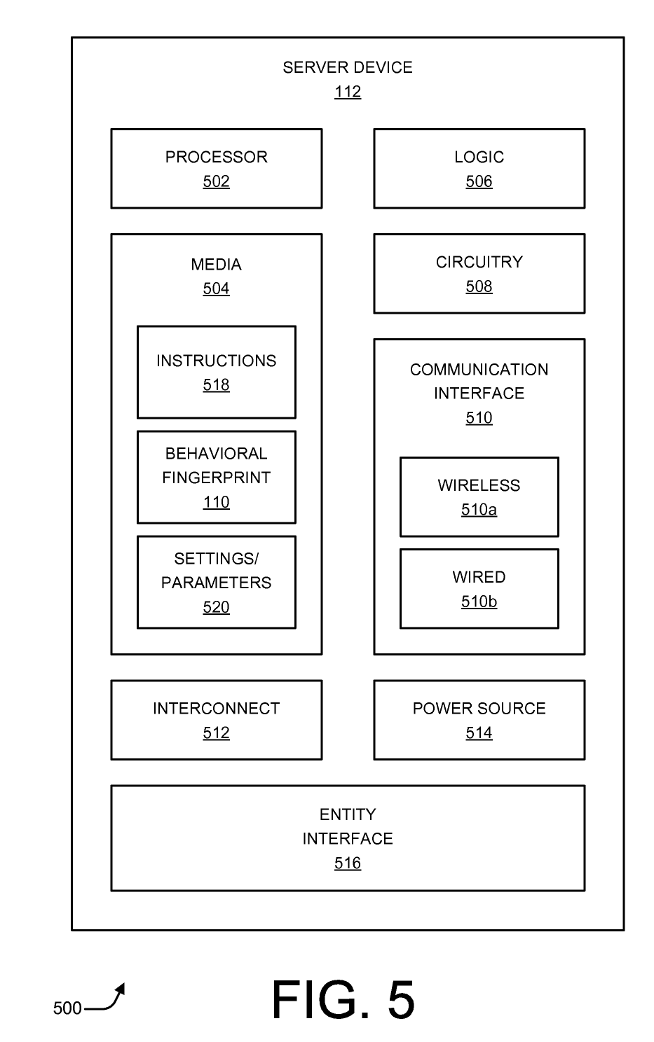

FIG. 5 is a schematic diagram 500 of an example server device including one or more example components in accordance with certain example embodiments. As shown in FIG. 5, a server device 112 may include one or more components such as: at least one processor 502, one or more media 504, logic 506, circuitry 508, at least one communication interface 510, at least one interconnect 512, at least one power source 514, at least one entity interface 516, some combination thereof, or so forth. Furthermore, as shown in schematic diagram 500, one or more media 504 may include one or more instructions 518, at least one behavioral fingerprint 110, one or more settings or parameters 520, some combination thereof, or so forth; or communication interface 510 may include at least one wireless communication interface 510a, at least one wired communication interface 510b, some combination thereof, or so forth. However, a server device 112 may alternatively include more, fewer, or different component(s) from those that are illustrated without departing from claimed subject matter.

For certain example embodiments, a server device 112 may include or comprise at least one processing or computing device or machine. Server device 112 may include or comprise, for example, a computing platform or any electronic device or devices having at least one processor or memory. Processor 502 may include, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 504 may bear, store, contain, include, provide access to, or a combination thereof, etc. instructions 518, which may be executable by a processor 502; at least one behavioral fingerprint 110; one or more settings/parameters 520; some combination thereof; or so forth. Instructions 518 may include or comprise, by way of example but not limitation, a program, a module, an application or app (e.g., that is native, that runs in a browser, that runs within a virtual machine or server, or a combination thereof, etc.), an operating system, or a combination thereof, etc. or portion thereof; operational data structures; source code, object code, just-in-time (JIT) compiled code, or a combination thereof, etc.; processor-executable instructions; other code; some combination thereof; or so forth. Media 504 may include, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, or a combination thereof, etc.) that is capable of bearing instructions, at least one behavioral fingerprint, settings, parameters, some combination thereof, or so forth.

For certain example embodiments, execution of instructions 518 by one or more processors 502 may transform server device 112 into a special-purpose computing device, apparatus, platform, machine, some combination thereof, or so forth. Instructions 518 may include, for example, instructions that are capable of realizing at least a portion of one or more flow diagrams methods, processes, procedures, operations, functionality, technology, mechanisms, or a combination thereof, etc. that are described herein or illustrated in the accompanying drawings. Settings/parameters 520 may include, by way of example but not limitation, one or more settings or parameters that may be established by a user or other entity, one or more settings or parameters that may be determined by a server device 112, one or more settings or parameters that may be determined by a user or other entity, one or more settings or parameters that may be detected by a server device 112, one or more settings or parameters that may be received from another device that detected them, one or more settings or parameters that may determine at least partly how a server device 112 is to operate or respond to a situation or a behavioral fingerprint, one or more settings or parameters (e.g., values) that may be used to realize flow diagrams, methods, processes, procedures, operations, functionality, technology, mechanisms, or a combination thereof, etc. that are described herein or illustrated in the accompanying drawings. Settings/parameters 520 may control at least partially how at least one behavioral fingerprint 110 is configured, stored, shared, used, applied, some combination thereof, or so forth. Additionally or alternatively, at least a portion of settings/parameters 520 may be at least partially integrated with at least one behavioral fingerprint 110.

For certain example embodiments, logic 506 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings. Circuitry 508 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings, wherein circuitry 508 includes at least one physical or hardware component or aspect.

For certain example embodiments, one or more communication interfaces 510 may provide one or more interfaces between server device 112 and another device or a person/operator/entity directly or indirectly. A wireless communication interface 510a or a wired communication interface 510b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, a gateway, or a combination thereof, etc.), a physical or logical network adapter or port, a frequency converter, a baseband processor, an Internet or telecommunications backbone connector, a fiber optic connector, a storage area network (SAN) connector, or a combination thereof, etc. to communicate wireless signals or wired signals via one or more wireless communication links or wired communication links, respectively, such as over one or more channels 108 (e.g., of FIGS. 1 and 2A). Communications with at least one communication interface 510 may enable transmitting, receiving, or initiating of transmissions, just to name a few examples.

For certain example embodiments, at least one interconnect 512 may enable signal communication between or among components of server device 112. Interconnect 512 may include, by way of example but not limitation, one or more buses, channels, switching fabrics, local area networks (LANs), storage area networks (SANs), some combination thereof, or so forth. Although not explicitly illustrated in FIG. 5, one or more components of server device 112 may be coupled to interconnect 512 via a discrete or integrated interface. By way of example only, one or more interfaces may couple a processor 502 or a medium 504 to at least one interconnect 512. For certain example embodiments, at least one power source 514 may provide power to one or more components of server device 112. Power source 514 may include, by way of example but not limitation, a power connector for accessing an electrical grid, a fuel cell, a solar power source, some combination thereof, or so forth.

For certain example embodiments, an entity interface 516 may enable one or more entities (e.g., another device, a person, a group, a robotic entity, or a combination thereof, etc.) to provide input to or receive output from server device 112. Interactions between an entity and a device may relate, by way of example but not limitation, to inputting or outputting instructions, commands, settings, parameters, indications, some combination thereof, or so forth. Certain entity interfaces 516 may enable both entity input and entity output at server device 112 or over at least one network link, such as one or more channels 108 (e.g., of FIGS. 1 and 2A).

However, claimed subject matter is not limited to any particular described embodiments, implementations, examples, or so forth. For instance, it should be understood that for certain example implementations components that are illustrated separately in FIG. 5 need not necessarily be separate or mutually exclusive. For example, a given component may provide multiple functionalities. By way of example only, hard-wired logic 506 may form circuitry 508. Additionally or alternatively, a single component such as a connector may function as a communication interface 510 or as an entity interface 516. Additionally or alternatively, one or more instructions 518 may function to realize at least one setting or parameter 520.

It should also be understood that for certain example implementations components that are illustrated in schematic diagram 500 or described herein may not be integral or integrated with a server device 112. For example, a component may be removably connected to a server device 112, a component may be wirelessly coupled to a server device 112, one or more components of a server device 112 may be geographically distributed or separated from one another, some combination thereof, or so forth. By way of example only, instructions 518 may be stored on one medium 504, and settings/parameters 520 (or another portion of instructions 518) may be stored on a different medium 504, which may include a same server or a part of a different server of, e.g., a server farm. Additionally or alternatively, respective processor-media sets may be physically realized on different or respective server blades or server containers. Multiple server blades, for instance, may be linked or interlinked to realize at least one server device 112. However, claimed subject matter is not limited to any particular described embodiments, implementations, examples, etc.

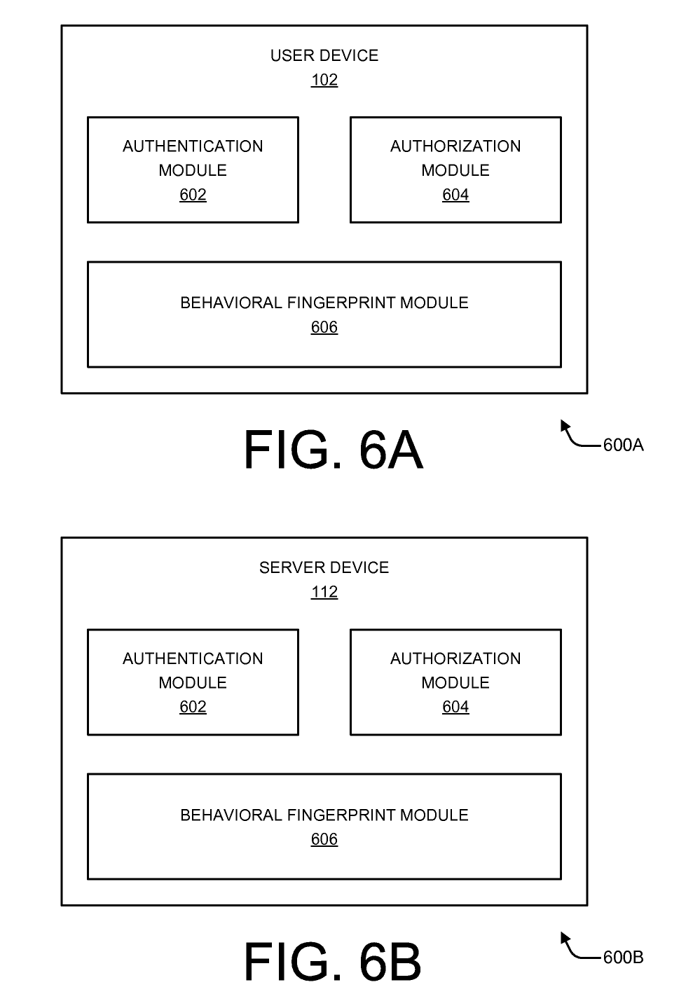

FIGS. 6A and 6B are schematic diagrams 600A and 600B of an example user device and an example server device, respectively, that have one or more functional modules in accordance with certain example embodiments. As shown in FIGS. 6A and 6B, by way of example but not limitation, schematic diagrams 600A and 600B may depict a user device 102 and a server device 112, respectively. As illustrated in schematic diagrams 600A and 600B, a user device 102 or a server device 112 may include, but are not limited to, at least one authentication module 602, at least one authorization module 604, at least one behavioral fingerprint module 606, a combination thereof, or so forth. However, a user device 102 or a server device 112 may alternatively include more, fewer, or different module(s) from those that are illustrated without departing from claimed subject matter.

For certain example embodiments, a module may include or be comprised of at least one processor (e.g., a processor 402 of FIG. 4, a processor 502 of FIG. 5, or a combination thereof, etc.), one or more media (e.g., a medium 404 of FIG. 4, a media medium 504 of FIG. 5, or a combination thereof, etc.), instructions (e.g., processor-executable instructions, instructions 420 of FIG. 4, instructions 518 of FIG. 5, computer-implementable instructions, or a combination thereof, etc.), logic (e.g., logic 406 of FIG. 4, logic 506 of FIG. 5, or a combination thereof, etc.), circuitry (e.g., circuitry 408 of FIG. 4, circuitry 508 of FIG. 5, or a combination thereof, etc.), other described or illustrated component(s), some combination thereof, or so forth. For certain example implementations, one or more modules (e.g., an authentication module 602, an authorization module 604, a behavioral fingerprint module 606, or a combination thereof, etc.) of at least one user device 102 may function or interoperate with one or more modules of at least one server device 112. However, claimed subject matter is not limited to any particular described embodiments, implementations, examples, etc.

For certain example embodiments, an authentication module 602 may operate to authenticate a user of a device. For certain example implementations, a user of a device may be authenticated by determining to some (e.g., reasonable, acceptable, measurable, quantifiable, or a combination thereof, etc.) degree an identity of a user. By way of example but not limitation, an authentication module 602 may enable implementation of multiple degrees of authentication, with different degrees of authentication corresponding to different levels of certainty of an identity of a user. Example aspects related to authentication are described further herein (e.g., at least herein above with particular reference to FIG. 1). However, claimed subject matter is not limited to any particular described embodiments, implementations, examples, etc.

For certain example embodiments, an authorization module 604 may operate to permit or enable full or at least partial access to, use of, implementation of, execution of, or a combination thereof, etc. one or more features, applications, accounts, profiles, data, capabilities, or a combination thereof, etc. of at least one device, such as a user device 102 or a server device 112. For certain example implementations, authorization may be fully or at least partially granted, denied, withheld, or a combination thereof, etc. based at least partially on an authentication determination, a result from an authentication module 602, some combination thereof, or so forth. By way of example but not limitation, an authorization module 604 may provide for different levels of authorization, including but not limited to for a given authorized user, that correspond to different degrees of authentication, that correspond to different user identities, some combination thereof, or so forth. Example aspects related to authorization are described further herein (e.g., at least herein above with particular reference to FIG. 1). However, claimed subject matter is not limited to any particular described embodiments, implementations, examples, etc.

For certain example embodiments, a behavioral fingerprint module 606 may operate to implement, perform, facilitate performance of, or a combination thereof, etc. one or more flow diagrams, methods, processes, procedures, operations, functionality, technology, mechanisms, or a combination thereof, etc. that are described herein or illustrated in the accompanying drawings or that relate to at least one behavioral fingerprint. For certain example implementations, a behavioral fingerprint module 606 may provide information, monitored acts, likelihood values, determinations, comparisons, analyses, indications, predicted acts, or a combination thereof, etc. to an authentication module 602 on which it may at least partially base an authentication determination. Example aspects related to behavioral fingerprinting are described further herein above and below. However, claimed subject matter is not limited to any particular described embodiments, implementations, examples, etc.

FIG. 7A is a schematic diagram 700A that includes at least one example device that is capable of handling scenarios for behavioral fingerprinting via social network verification in accordance with certain example embodiments. As shown in FIG. 7A, by way of example but not limitation, schematic diagram 700A includes at least one device that may include a task attempt detection module 702 or a verification inquiry transmission initiation module 704. More specifically, schematic diagram 700A may include a user device 102 or a server device 112. By way of example but not limitation, a task attempt detection module 702 or a verification inquiry transmission initiation module 704 may include or comprise or be realized with at least one processor that executes instructions (e.g., sequentially, in parallel, at least partially overlapping in a time-multiplexed fashion, at least partially across multiple cores, or a combination thereof, etc.) as at least one special-purpose computing component, or otherwise as described herein. However, claimed subject matter is not limited to any particular described embodiments, implementations, examples, etc.

For certain example embodiments, a task attempt detection module 702 or a verification inquiry transmission initiation module 704 may be implemented separately or at least partially jointly or in combination. A task attempt detection module 702 may be configured to detect at least one attempt to perform at least one task via at least one user device. A verification inquiry transmission initiation module 704 may be configured to initiate transmission of at least one verification inquiry to one or more social network connections based at least partly on the at least one attempt to perform the at least one task via the at least one user device. However, claimed subject matter is not limited to any particular described embodiments, implementations, examples, etc.

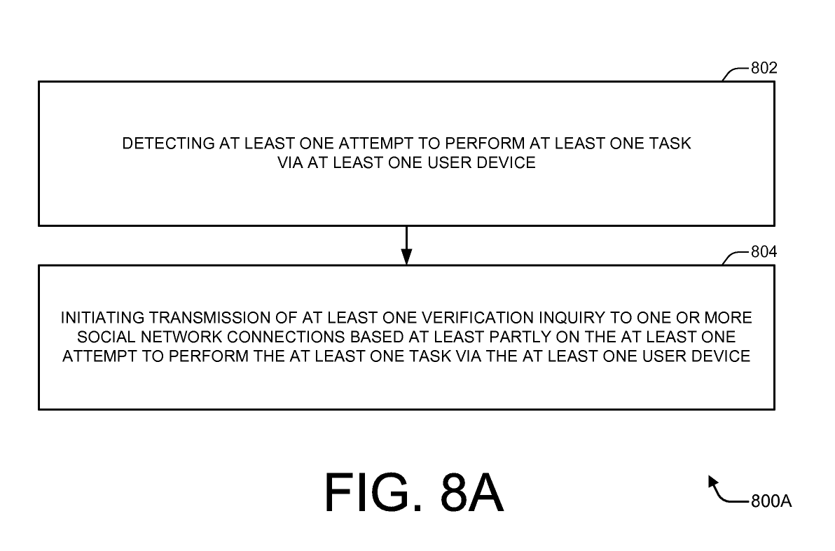

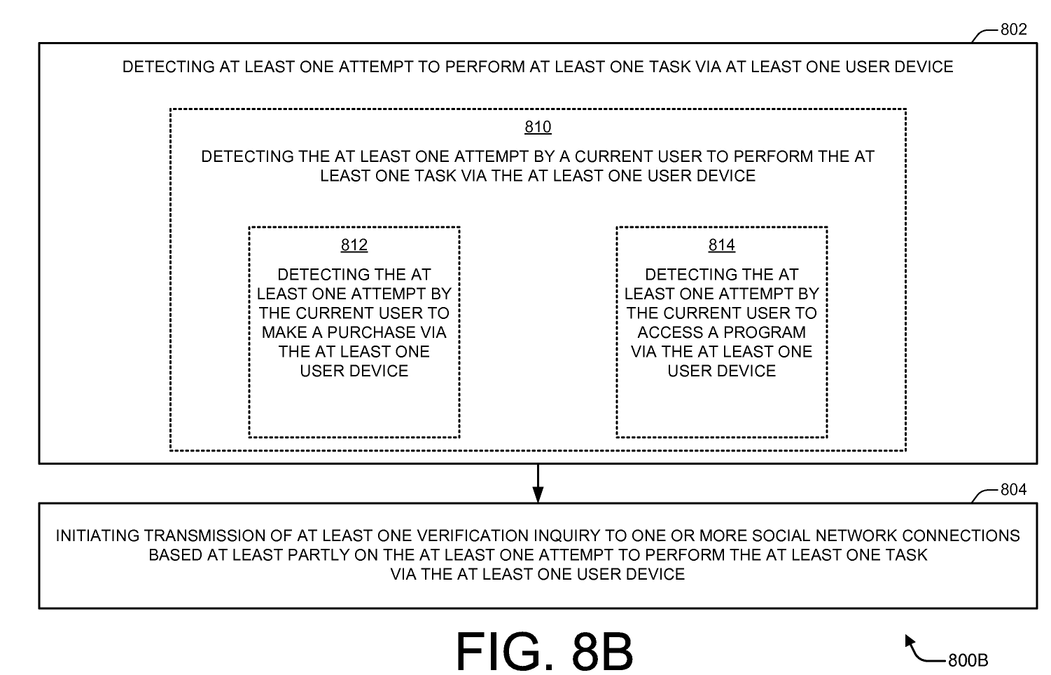

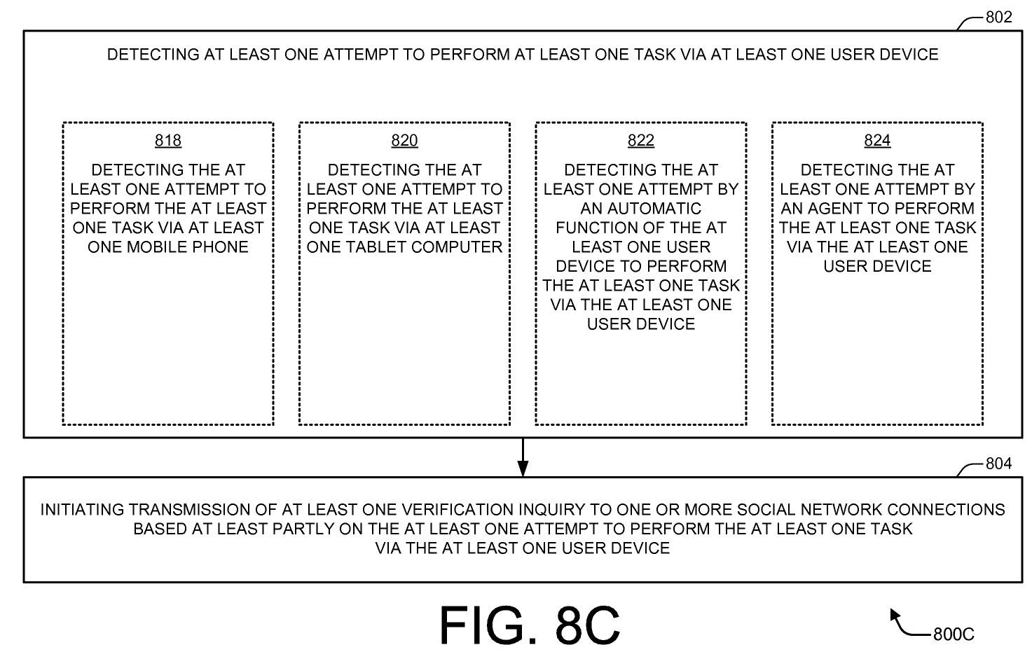

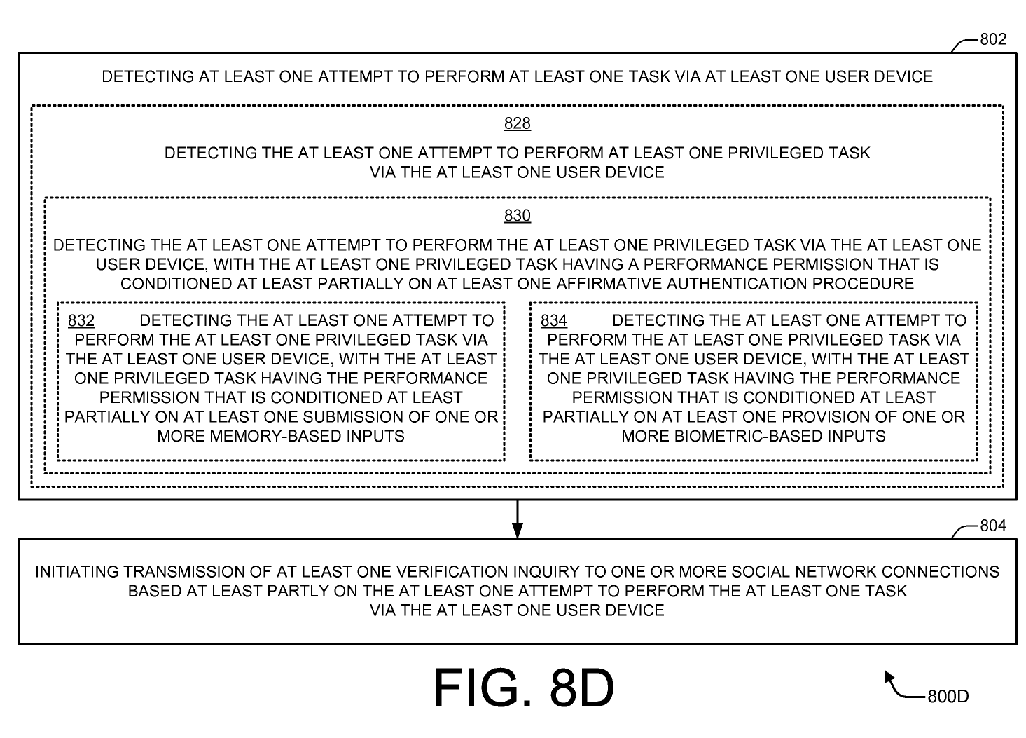

FIGS. 7B-7C are schematic diagrams 700B-700C that include at least one example device and that depict example scenarios for implementing behavioral fingerprinting via social network verification in accordance with certain example embodiments. As shown in FIGS. 7B-7C, by way of example but not limitation, one or more of schematic diagrams 700B-700C may include at least one user device 102, at least one server device 112, at least one task 706, at least one task attempt detection 708, at least one verification inquiry 710, at least one transmission initiation 712, or one or more social network connections 714. Each of schematic diagrams 700B-700C may include alternative or additional depictions, which may relate to behavioral fingerprinting via social network verification, as described herein. In addition to or in alternative to description herein below with specific reference to FIGS. 7B-7C, illustrated aspects of schematic diagrams 700B-700C may be relevant to example description with reference to FIG. 8A-8D, 9A-9F, or 10A-10C. However, claimed subject matter is not limited to any particular described embodiments, implementations, examples, etc.

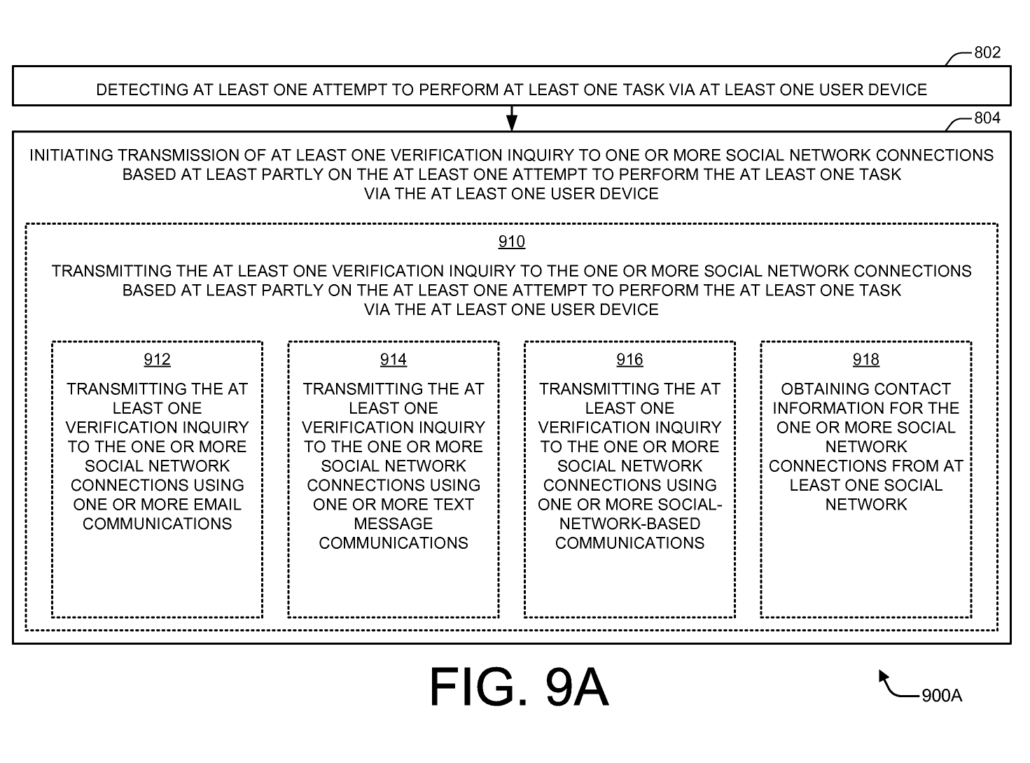

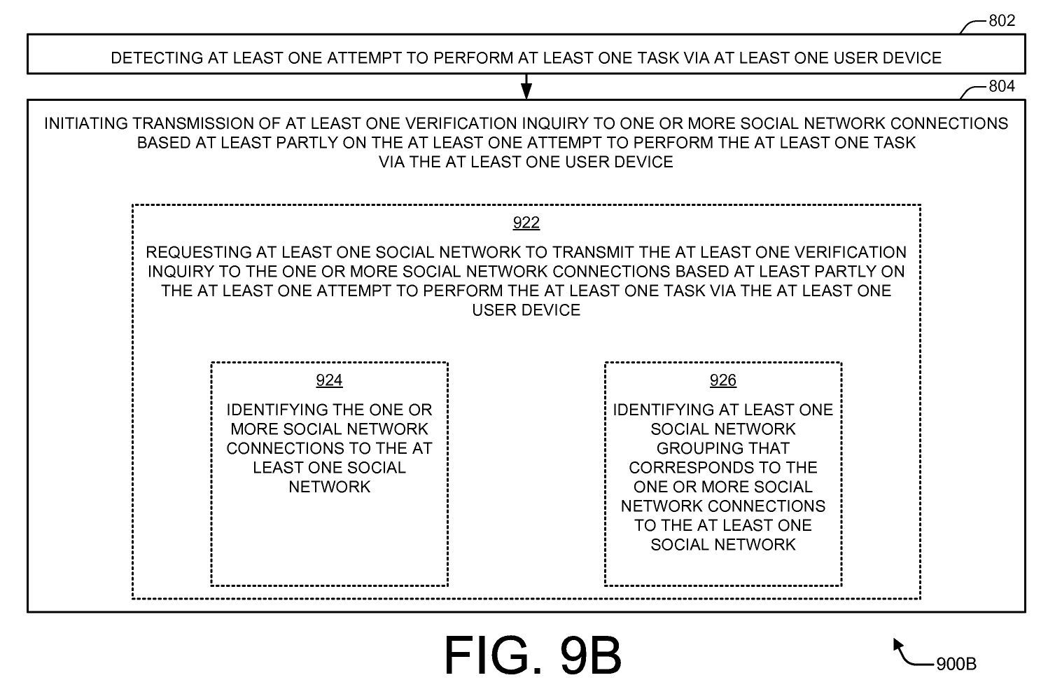

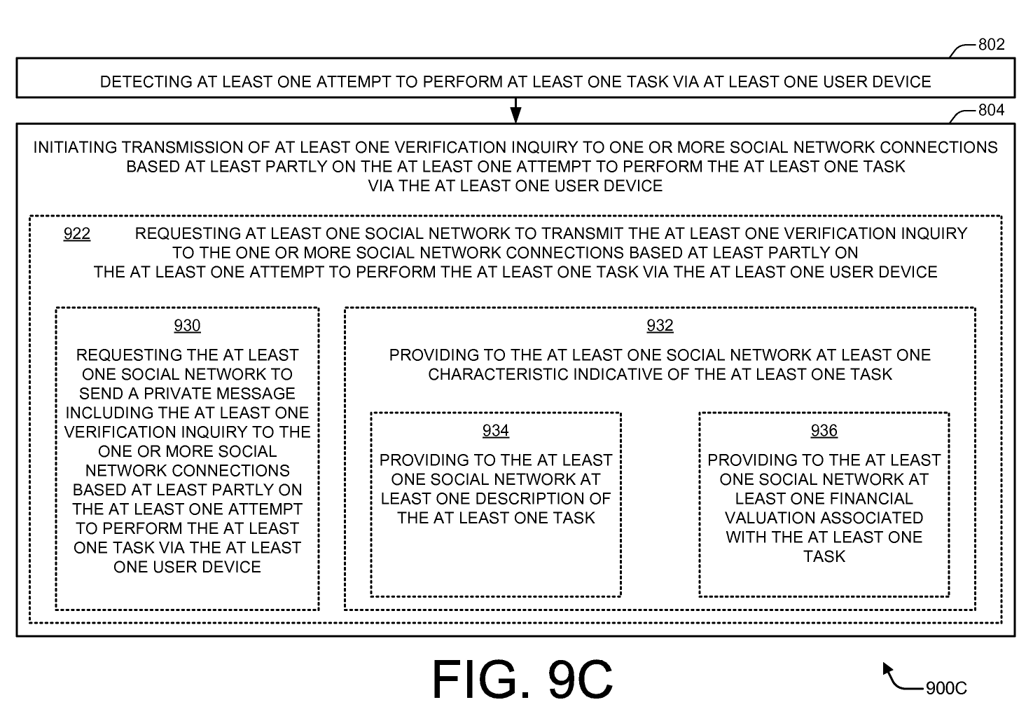

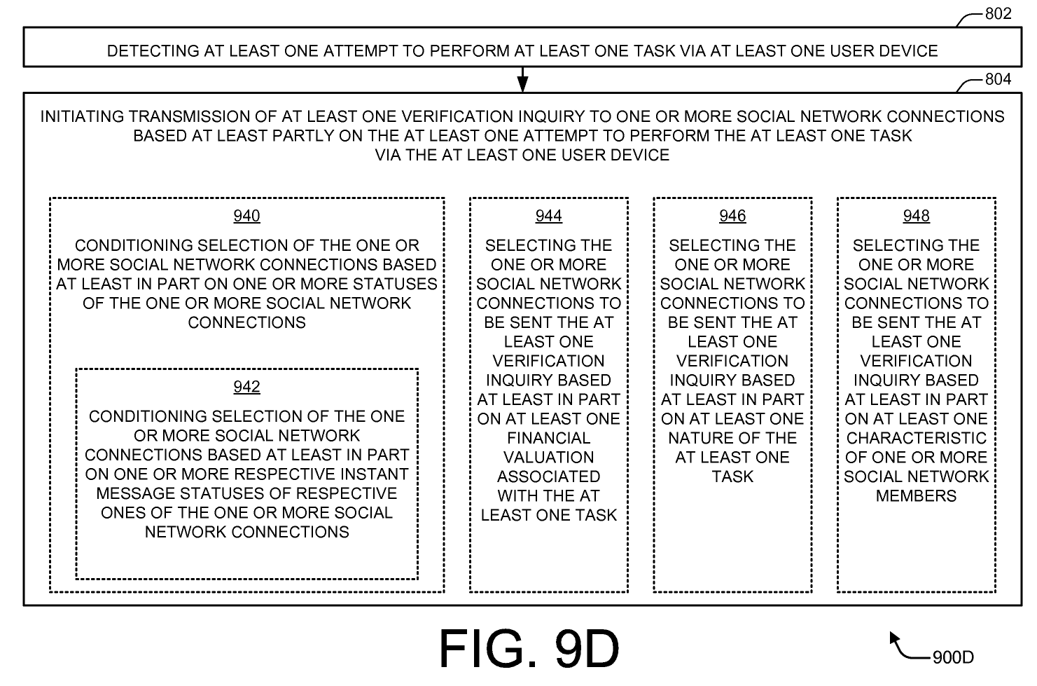

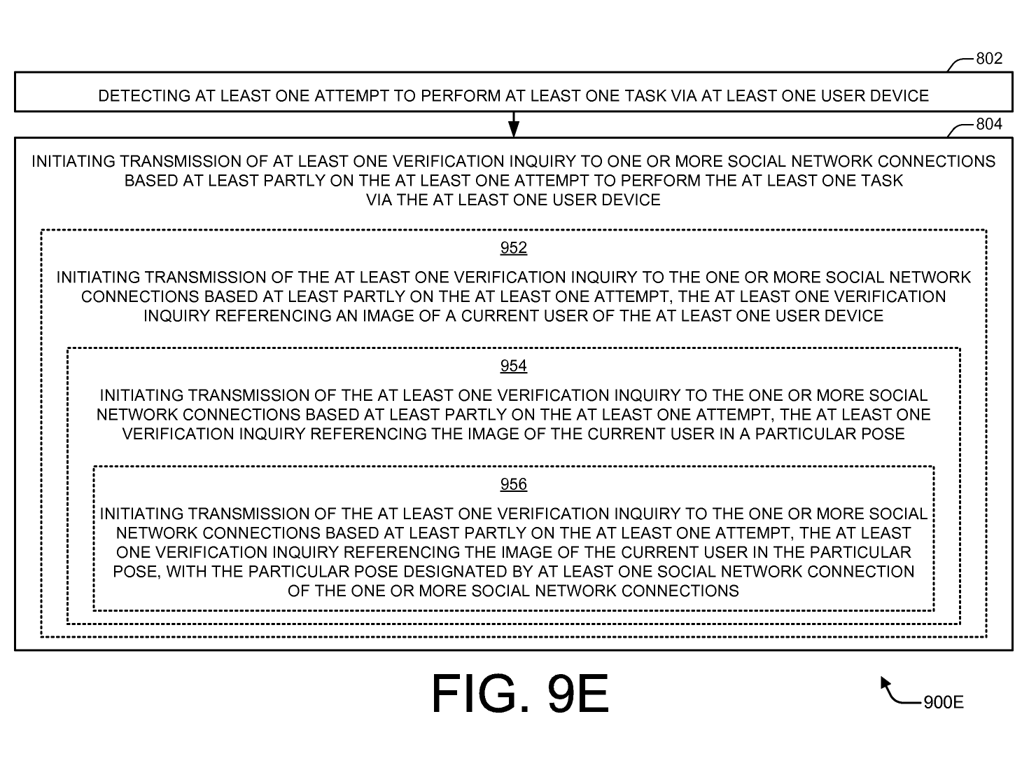

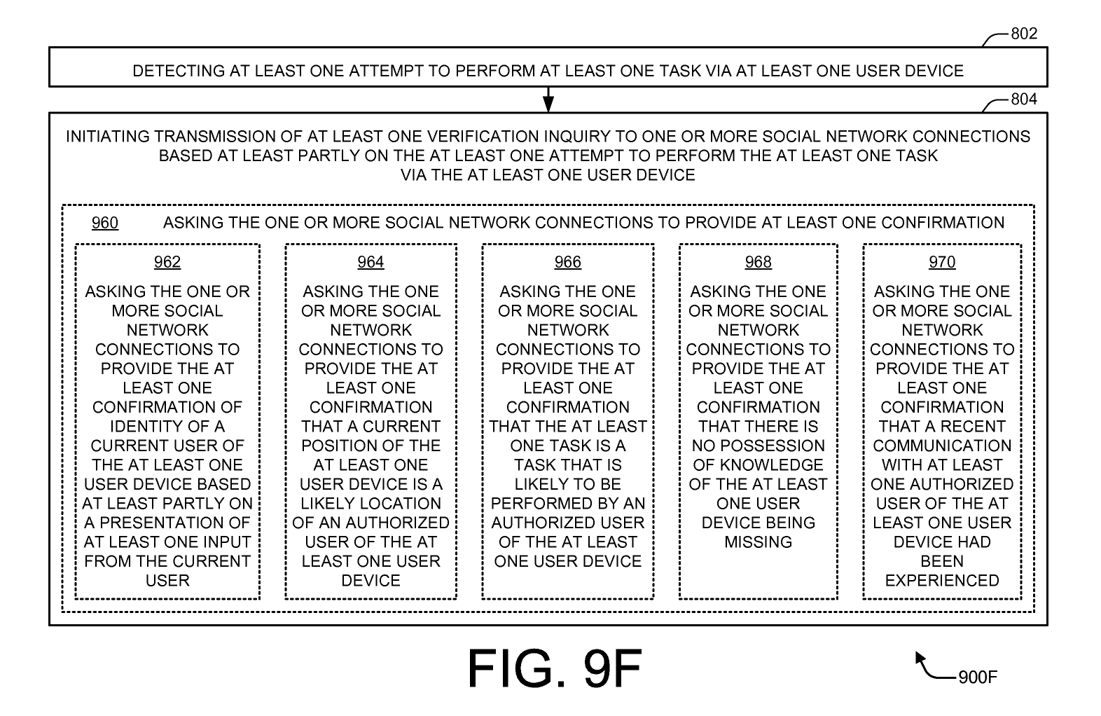

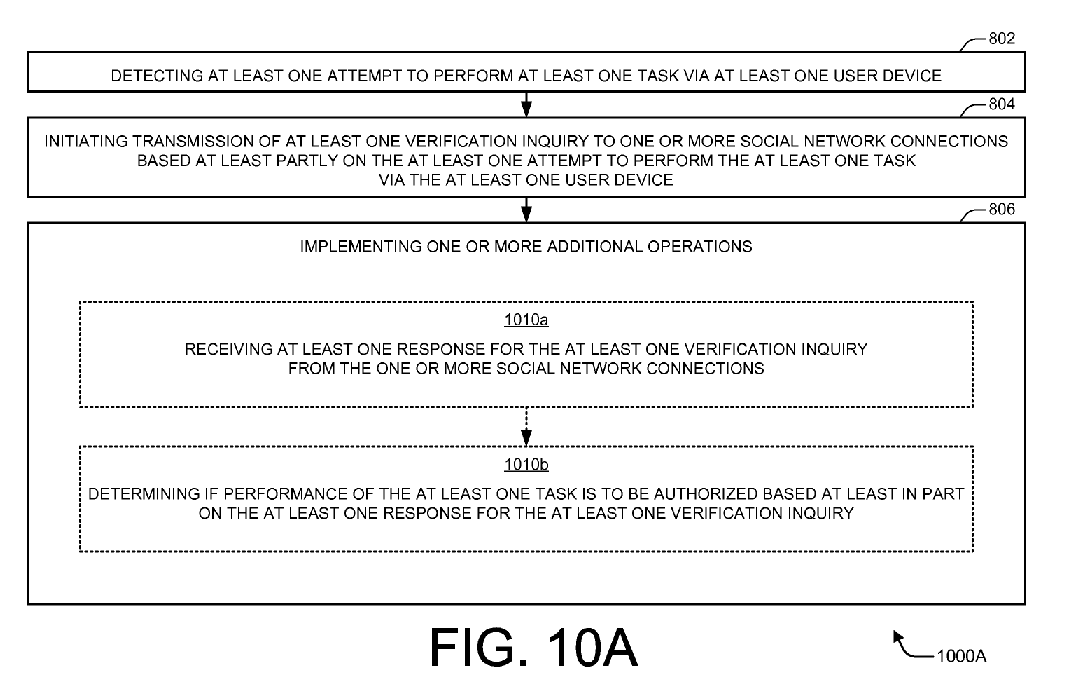

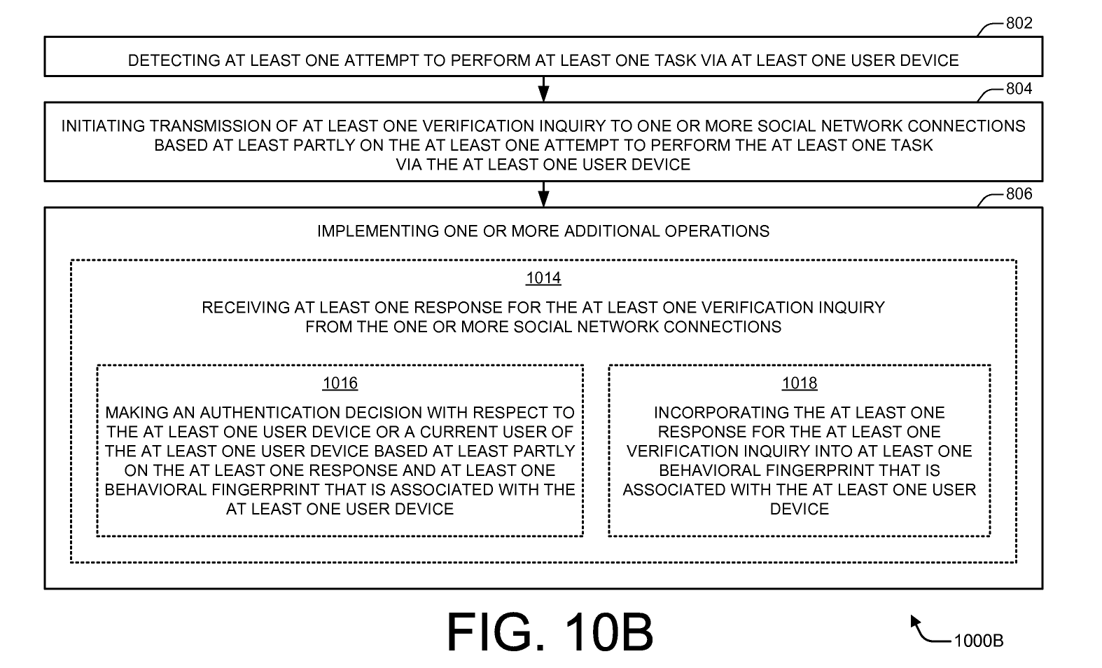

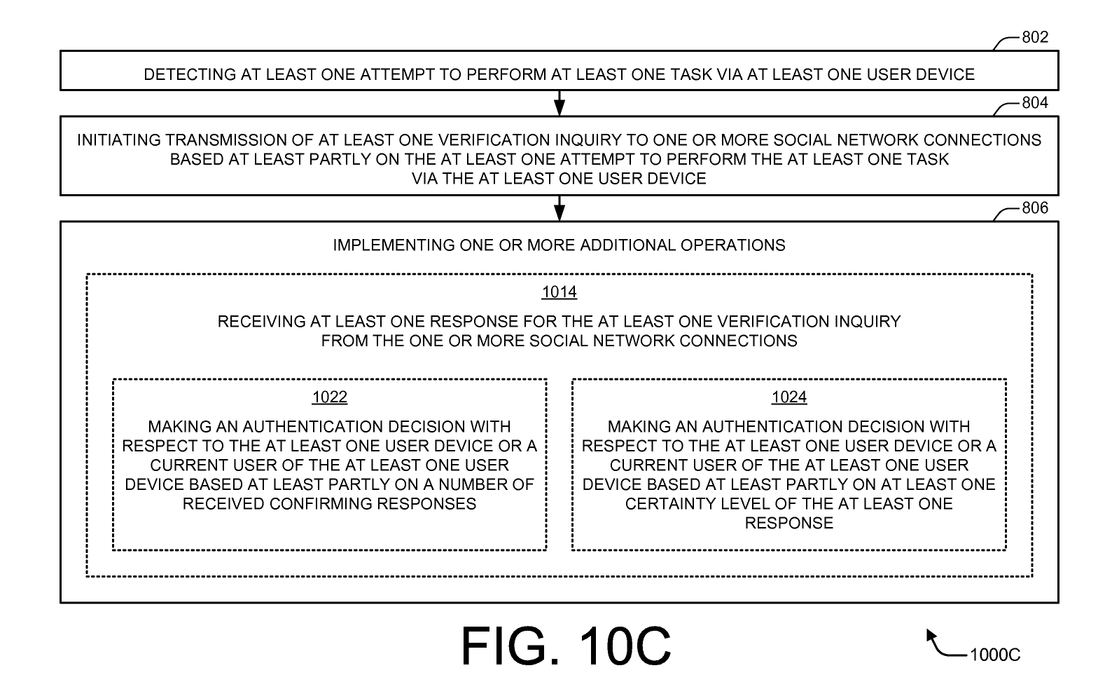

As shown in FIG. 7B, by way of example but not limitation, schematic diagram 700B may include at least one user device 102, at least one server device 112, at least one task 706, at least one task attempt detection 708, at least one verification inquiry 710, at least one transmission initiation 712, or one or more social network connections 714. For certain example embodiments, social network connections 714 may include social network members, contact information for social network members, people reachable via a social network mechanism, entities within a person's social network graph, individuals that are part of a social network grouping, a combination thereof, or so forth. However, at least one verification inquiry 710 may additionally or alternatively be sent to one or more contacts generally that are not necessarily from, in, or related to a social network (e.g., phone contacts such as iPhone contacts or Android contacts; email contacts such as Exchange, Gmail, or Outlook contacts; or a combination thereof; etc.). Additional or alternative description that may be relevant to schematic diagram 700B is provided herein below with particular reference to one or more of any of FIGS. 8A-8D, FIGS. 9A-9F, or FIGS. 10A-10C.

As shown in FIG. 7C, by way of example but not limitation, schematic diagram 700C may include at least one user device 102, at least one user 104, at least one behavioral fingerprint 110, at least one server device 112, at least one task 706, at least one task attempt detection 708, at least one verification inquiry 710, at least one transmission initiation 712, one or more social network connections 714, at least one social network 716, at least one other device 718, or at least one cloud 720. More specifically, for certain example embodiments, schematic diagram 700C may include: a user device 102 that may correspond to a user 104, which user may comprise an authorized user or an unauthorized user; a server device 112, which may operate within or as part of a cloud 720; a task 706, which may be attempted by or with user device 102; a task attempt detection 708, which may detect an attempt to perform a task 706; or a transmission initiation 712, which may initiate a transmission of a verification inquiry 710 to a social network connection 714. For certain example implementations, a cloud 720 may include at least a portion of a server device, one or more server devices, a provider or utilizer of a cloud service, a provider or utilizer of cloud computing, a combination thereof, or so forth. However, claimed subject matter is not limited to any particular described embodiments, implementations, examples, etc.

For certain example embodiments, an other device 718 may be operated or owned by a user 104 of a user device 102, may be operated or owned by a service provider, may be operated or owned by a social network 716, may be operated or owned by a third party, may be operated or owned by a proprietor of an establishment, may be operated by one of the above and owned by another, or so forth. For certain example implementations, other device 718 may be communicatively coupled to a user device 102, a server device 112, a combination thereof, or so forth. By way of example but not limitation, other device 718: may be integrated with a user device 102, may be physically connected to a user device 102, may be wirelessly coupled to a user device 102, may be coupled by wire to a user device 102, may be coupled by wire or wirelessly to a server device 112, some combination thereof, or so forth. Other device 718 may additionally or alternatively be capable of bidirectional or unidirectional communication with multiple servers 112 (e.g., of a cloud computing environment 720 or via one or more channels 108 (e.g., of FIGS. 1 and 2A), which channel(s) 108 may include at least part of at least one network, such as an internet). Other device 718 may include or comprise, by way of example but not limitation, a point-of-sale (POS) terminal, such as a register; an attachment augmenting a POS terminal; an attachment to a user device 102; a device that accepts credit, debit, or other payment cards and is coupled to a user device 102; a device that accepts or generates sensor readings and forwards them to a server 112; a device that collects, determines, or forwards location data; a device that forwards other data collected or produced at a user device 102 to a server 112; a combination thereof; or so forth. Data (e.g., relating to behavioral fingerprinting, social networking, confirmation information, user-device interactions, or a combination thereof, etc.) may be collected at or by other device 718 or funneled through other device 718 between or among at least one user device 102 or one or more server devices 112. However, claimed subject matter is not limited to any particular described embodiments, implementations, examples, etc.

For certain example embodiments, a server device 112 may be operated by or for a social network 716 (or other third party service provider). A social network 716 may include, by way of example but not imitation, a network, a service, an internet location, a website, a computing infrastructure, an application, an interface, cloud computing, or a combination thereof, etc. that enables or facilitates interaction (e.g., via text, images, audio, video, or a combination thereof, etc.) between or among two or more members of a social network. The term “social” in “social network” should not be interpreted to exclude networks designed or intended for professional or specific purposes. Examples of social networks may include, but are not limited to, Facebook, Google+, Twitter, LinkedIn, Myspace, Pinterest, Classmates[dot]com, Flickr, Foursquare, Friendster, LiveJournal, Meetup, Netlog, Orkut, Sina Weibo, Qzone, Habbo, Instagram, or so forth. However, claimed subject matter is not limited to any particular described embodiments, implementations, examples, etc. Additional or alternative description that may be relevant to schematic diagram 700C is provided herein below with particular reference to one or more of any of FIGS. 8A-8D, FIGS. 9A-9F, or FIGS. 10A-10C.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 8A is a flow diagram 800A illustrating an example method for at least one device with regard to behavioral fingerprinting via social network verification in accordance with certain example embodiments. As illustrated, flow diagram 800A may include any of operations 802-804. Although operations 802-804 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 800A may be performed so as to be fully or partially overlapping with other operation(s). For certain example embodiments, one or more operations of flow diagram 800A may be performed by at least one server device (e.g., a server device 112). Alternatively, one or more operations of flow diagram 800A may be performed by at least one user device (e.g., a user device 102).

For certain example embodiments, a method for behavioral fingerprinting via social network verification, which method may be at least partially implemented using hardware (e.g., circuitry, at least one processor, processor-accessible memory, or a combination thereof, etc.) such as that of a server device, may include an operation 802 or an operation 804. An operation 802 may be directed at least partially to detecting at least one attempt to perform at least one task via at least one user device. For certain example implementations, at least one device (e.g., a server device 112) may detect 708 (e.g., discover, ascertain, receive notification of, obtain an indication of, request to be reported to about, observe, or a combination thereof, etc.) at least one attempt (e.g., a request, an indication of an intent, a user-interface activation, a decision by code, an instruction to proceed, or a combination thereof, etc.) to perform (e.g., accomplish, implement, achieve, execute, start, take actions toward completing, carry out, operate, or a combination thereof, etc.) at least one task 706 (e.g., make a purchase via the internet, access a file, unlock a door or start a car, make an in-person purchase, launch an application, use an application or part thereof, access or send social network communications, utilize a function that incurs charges, utilize a capability that realizes an outgoing communication, or a combination thereof, etc.) via at least one user device 102 (e.g., a mobile device, a smartphone, a tablet computer, a laptop computer, a desktop computer, a vehicle, a portable entertainment device, or a combination thereof, etc.). By way of example but not limitation, a server may detect at least one attempt to perform at least one task via at least one user device (e.g., a server may detect that a mobile phone is trying to make a purchase or is to be employed by a user to make a purchase). However, claimed subject matter is not limited to any particular described embodiments, implementations, examples, etc.

For certain example embodiments, an operation 804 may be directed at least partially to initiating transmission of at least one verification inquiry to one or more social network connections based at least partly on the at least one attempt to perform the at least one task via the at least one user device. For certain example implementations, at least one device (e.g., a server device 112) may initiate transmission 712 of (e.g., transmit, formulate, request another entity to transmit, request another server to transmit, instruct at least partially how to send, provide a destination for, indicate contents for, or a combination thereof, etc.) at least one verification inquiry 710 (e.g., an email, a text message, an instant message, a phone call, a video call, an attachment such as text or imagery to a communication, a request to confirm identity, a request to confirm likelihood, a request to confirm location, a request to confirm knowledge, or a combination thereof, etc.) to one or more social network connections 714 (e.g., social network members, contact information for social network members, people reachable via a social network mechanism, entities within a person's social network graph, individuals that are part of a social network grouping, or a combination thereof, etc.) based at least partly on at least one attempt to perform at least one task 706 via at least one user device 102. By way of example but not limitation, a server may initiate transmission of at least one verification inquiry to one or more social network connections based at least partly on the at least one attempt to perform the at least one task via the at least one user device (e.g., a server, based at least partially on a detected purchase attempt, may send an inquiry to at least one social network member asking if a current user of a mobile phone appears to be an authorized user thereof or asking if an authorized user would be likely to want to make such a purchase). However, claimed subject matter is not limited to any particular described embodiments, implementations, examples, etc.

FIGS. 8B-8D depict example additions or alternatives for a flow diagram of FIG. 8A in accordance with certain example embodiments. As illustrated, flow diagrams of FIGS. 8B-8D may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 8B-8D may be performed so as to be fully or partially overlapping with other operation(s). For certain example embodiments, one or more operations of flow diagrams 800B-800D (of FIGS. 8B-8D) may be performed by at least one server device (e.g., a server device 112). Alternatively, one or more operations of flow diagrams 800B-800D may be performed by at least one user device (e.g., a user device 102).

FIG. 8B illustrates a flow diagram 800B having example operations 810, 812, or 814. For certain example embodiments, an operation 810 may be directed at least partially to wherein the detecting at least one attempt to perform at least one task via at least one user device (of operation 802) includes detecting the at least one attempt by a current user to perform the at least one task via the at least one user device. For certain example implementations, at least one device (e.g., a server device 112) may detect 708 at least one attempt by a current user 104 (e.g., a person operating, manipulating, holding, currently possessing, or a combination thereof, etc. at least one user device) to perform at least one task 706 via at least one user device 102. By way of example but not limitation, at least one server may detect the at least one attempt by a current user to perform the at least one task via the at least one user device (e.g., a Microsoft server may receive an authorization request for a current user of an HTC Windows Mobile Phone 8 to be permitted to download a movie). However, claimed subject matter is not limited to any particular described embodiments, implementations, examples, etc.

For certain example embodiments, an operation 812 may be directed at least partially to wherein the detecting the at least one attempt by a current user to perform the at least one task via the at least one user device (of operation 810) includes detecting the at least one attempt by the current user to make a purchase via the at least one user device. For certain example implementations, at least one device (e.g., a server device 112) may detect 708 at least one attempt by a current user 104 to make a purchase (e.g., order pizza delivery, buy a chair at an Ikea store, license use of software, order a book via the internet, buy a song, pay for a subscription to media, or a combination thereof, etc.) via at least one user device 102. By way of example but not limitation, at least one server may detect the at least one attempt by the current user to make a purchase via the at least one user device (e.g., an Apple server may be asked to approve an in-person purchase via an iPhone using Apples' Passbook). However, claimed subject matter is not limited to any particular described embodiments, implementations, examples, etc.

For certain example embodiments, an operation 814 may be directed at least partially to wherein the detecting the at least one attempt by a current user to perform the at least one task via the at least one user device (of operation 810) includes detecting the at least one attempt by the current user to access a program via the at least one user device. For certain example implementations, at least one device (e.g., a server device 112) may detect 708 at least one attempt by a current user 104 to access a program (e.g., launch a program, download an app, access a file using an application, utilize functionality of a program, install an application, update a program, view data controlled by an app, send a communication via a program, or a combination thereof, etc.) via at least one user device 102. By way of example but not limitation, at least one server may detect the at least one attempt by the current user to access a program via the at least one user device (e.g., a Verizon Wireless server may be notified that a current user is attempting to access an email program that is native to an Android tablet that is receiving wireless service from Verizon). However, claimed subject matter is not limited to any particular described embodiments, implementations, examples, etc.

FIG. 8C illustrates a flow diagram 800C having example operations 818, 820, 822, or 824. For certain example embodiments, an operation 818 may be directed at least partially to wherein the detecting at least one attempt to perform at least one task via at least one user device (of operation 802) includes detecting the at least one attempt to perform the at least one task via at least one mobile phone. For certain example implementations, at least one device (e.g., a server device 112) may detect 708 at least one attempt to perform at least one task 706 via at least one mobile phone (e.g., a smartphone, a feature phone, an internet-connected phone, a phone with near field communication (NFC) capability, a portable electronic device that is capable of making voice calls, a location-aware phone, or a combination thereof, etc.). By way of example but not limitation, at least one server may detect the at least one attempt to perform the at least one task via at least one mobile phone (e.g., an Apple server may detect an attempt to order concert tickets with an Apple Passbook functionality of an iPhone). However, claimed subject matter is not limited to any particular described embodiments, implementations, examples, etc.

For certain example embodiments, an operation 820 may be directed at least partially to wherein the detecting at least one attempt to perform at least one task via at least one user device (of operation 802) includes detecting the at least one attempt to perform the at least one task via at least one tablet computer. For certain example implementations, at least one device (e.g., a server device 112) may detect 708 at least one attempt to perform at least one task 706 via at least one tablet computer (e.g., a slate computer, a pad-sized computer, a tablet-sized computational device, a portable screen with processing components built therein, or a combination thereof, etc.). By way of example but not limitation, at least one server may detect the at least one attempt to perform the at least one task via at least one tablet computer (e.g., a Microsoft server may detect an attempt by a user to check email with Microsoft Outlook via a Microsoft Surface tablet computer). However, claimed subject matter is not limited to any particular described embodiments, implementations, examples, etc.

For certain example embodiments, an operation 822 may be directed at least partially to wherein the detecting at least one attempt to perform at least one task via at least one user device (of operation 802) includes detecting the at least one attempt by an automatic function of the at least one user device to perform the at least one task via the at least one user device. For certain example implementations, at least one device (e.g., a server device 112) may detect 708 at least one attempt by an automatic function (e.g., a computerized-function, a built-in feature, an action that is effectuated electronically without contemporaneous human direction, a decision by an electronic agent, a signal that is to be provided by a device as a result of a setting or instruction previously established by a person or other entity, or a combination thereof, etc.) of at least one user device 102 to perform at least one task 706 via at least one user device 102. By way of example but not limitation, at least one server may detect the at least one attempt by an automatic function of the at least one user device to perform the at least one task via the at least one user device (e.g., a McAfee server may detect that a vehicle key fob is attempting to automatically unlock a door to a house responsive to a proximity between the vehicle key fob and the door to the house). However, claimed subject matter is not limited to any particular described embodiments, implementations, examples, etc.

For certain example embodiments, an operation 824 may be directed at least partially to wherein the detecting at least one attempt to perform at least one task via at least one user device (of operation 802) includes detecting the at least one attempt by an agent to perform the at least one task via the at least one user device. For certain example implementations, at least one device (e.g., a server device 112) may detect 708 at least one attempt by an agent (e.g., an electronic agent, code executing on a device, a stationary agent, a roving agent, an at least partially-autonomous agent, a human agent, a designated representative, an entity empowered to act on behalf of an authorized user, or a combination thereof, etc.) to perform at least one task 706 via at least one user device 102. By way of example but not limitation, at least one server may detect the at least one attempt by an agent to perform the at least one task via the at least one user device (e.g., a Southwest Airlines server may receive a request to book two tickets to fly from Chicago (Midway), IL to Fort Lauderdale, Fla. from an agent executing on a Dell laptop computer). However, claimed subject matter is not limited to any particular described embodiments, implementations, examples, etc.

FIG. 8D illustrates a flow diagram 800D having example operations 828, 830, 832, or 834. For certain example embodiments, an operation 828 may be directed at least partially to wherein the detecting at least one attempt to perform at least one task via at least one user device (of operation 802) includes detecting the at least one attempt to perform at least one privileged task via the at least one user device. For certain example implementations, at least one device (e.g., a server device 112) may detect 708 at least one attempt to perform at least one privileged task (e.g., a task that by default cannot be performed without signing-in, a task that ordinarily requires an affirmative authentication, a task that typically involves some assertion or evidence of identity or authorization to be commenced or completed, a task that is at least partially blocked from an unauthorized user, or a combination thereof, etc.) via at least one user device 102. By way of example but not limitation, at least one server may detect the at least one attempt to perform at least one privileged task via the at least one user device (e.g., a Norton server may detect that a current user is attempting to incur a fee on behalf of an authorized user of an LG Android phone). However, claimed subject matter is not limited to any particular described embodiments, implementations, examples, etc.

For certain example embodiments, an operation 830 may be directed at least partially to wherein the detecting the at least one attempt to perform at least one privileged task via the at least one user device (of operation 828) includes detecting the at least one attempt to perform the at least one privileged task via the at least one user device, with the at least one privileged task having a performance permission that is conditioned at least partially on at least one affirmative authentication procedure. For certain example implementations, at least one device (e.g., a server device 112) may detect 708 at least one attempt to perform at least one privileged task via at least one user device 102, with the at least one privileged task having a performance permission (e.g., an ability to proceed, a capability to be completed, an authorization to be accessed, an opportunity to be started, or a combination thereof, etc.) that is conditioned (e.g., that depends, that is preconditioned, that is a function of, that requires an existence of, that expects to first ensure a previous or contemporaneous administration of, that is based, or a combination thereof, etc.) at least partially on at least one affirmative authentication procedure (e.g., entering a password, passcode, passpattern, or a combination thereof, etc.; providing a biometric input such as a facial image, a fingerprint, an iris scan, or a combination thereof, etc.; answering one or more questions; some combination thereof; or so forth). By way of example but not limitation, at least one server may detect the at least one attempt to perform the at least one privileged task via the at least one user device, with the at least one privileged task having a performance permission that is conditioned at least partially on at least one affirmative authentication procedure (e.g., an Amazon server may determine that a user is attempting to order a product with a Kindle Fire tablet computer and some indicia of identity or approval from an authorized user, such as a PIN, is ordinarily entered via a virtual keyboard prior to acceptance or processing of an order). However, claimed subject matter is not limited to any particular described embodiments, implementations, examples, etc.

For certain example embodiments, an operation 832 may be directed at least partially to wherein the detecting the at least one attempt to perform the at least one privileged task via the at least one user device, with the at least one privileged task having a performance permission that is conditioned at least partially on at least one affirmative authentication procedure (of operation 830) includes detecting the at least one attempt to perform the at least one privileged task via the at least one user device, with the at least one privileged task having the performance permission that is conditioned at least partially on at least one submission of one or more memory-based inputs. For certain example implementations, at least one device (e.g., a server device 112) may detect 708 at least one attempt to perform at least one privileged task via at least one user device 102, with the at least one privileged task having a performance permission that is conditioned at least partially on at least one submission (e.g., entry, keyboard presses, screen touches, speech vocalization, provision, or a combination thereof, etc.) of one or more memory-based inputs (e.g., things that can be recalled mentally, an alphanumeric or other character-based password, a PIN, a pattern traced on a display screen, a pattern traced over a picture, a verbalized word or words, a particular sound, a tapping pattern or cadence, question answers, or a combination thereof, etc.). By way of example but not limitation, at least one server may detect the at least one attempt to perform the at least one privileged task via the at least one user device, with the at least one privileged task having the performance permission that is conditioned at least partially on at least one submission of one or more memory-based inputs (e.g., an Apple server may realize that a current user is attempting to make a post to Facebook and an authorized user has established controls such that social network postings ordinarily are barred absent entry of a password or passpattern). However, claimed subject matter is not limited to any particular described embodiments, implementations, examples, etc.

For certain example embodiments, an operation 834 may be directed at least partially to wherein the detecting the at least one attempt to perform the at least one privileged task via the at least one user device, with the at least one privileged task having a performance permission that is conditioned at least partially on at least one affirmative authentication procedure (of operation 830) includes detecting the at least one attempt to perform the at least one privileged task via the at least one user device, with the at least one privileged task having the performance permission that is conditioned at least partially on at least one provision of one or more biometric-based inputs. For certain example implementations, at least one device (e.g., a server device 112) may detect 708 at least one attempt to perform at least one privileged task via at least one user device 102, with the at least one privileged task having a performance permission that is conditioned at least partially on at least one provision (e.g., offering, flesh pressing, image exposure to a camera, speaking to a microphone, writing on a sensor, submission, or a combination thereof, etc.) of one or more biometric-based inputs (e.g., a fingerprint, an iris scan, a facial image, a speech sample, a palm print, a writing sample, a blood sample, a hair sample, or a combination thereof, etc.). By way of example but not limitation, at least one server may detect the at least one attempt to perform the at least one privileged task via the at least one user device, with the at least one privileged task having the performance permission that is conditioned at least partially on at least one provision of one or more biometric-based inputs (e.g., a Google server for Google Wallet may discover from a communication sent by an Android phone or by a merchant that the Android phone is trying to buy a dress, wherein such Google Wallet usage would ordinarily be predicated on providing a fingerprint or facial image prior to considering whether the purchase is to be approved). However, claimed subject matter is not limited to any particular described embodiments, implementations, examples, etc.

FIGS. 9A-9F depict example additions or alternatives for a flow diagram of FIG. 8A in accordance with certain example embodiments. As illustrated, flow diagrams of FIGS. 9A-9F may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 9A-9F may be performed so as to be fully or partially overlapping with other operation(s). For certain example embodiments, one or more operations of flow diagrams 900A-900F (of FIGS. 9A-9F) may be performed by at least one server device (e.g., a server device 112). Alternatively, one or more operations of flow diagrams 900A-900F may be performed by at least one user device (e.g., a user device 102).

FIG. 9A illustrates a flow diagram 900A having example operations 910, 912, 914, 916, or 918. For certain example embodiments, an operation 910 may be directed at least partially to wherein the initiating transmission of at least one verification inquiry to one or more social network connections based at least partly on the at least one attempt to perform the at least one task via the at least one user device (of operation 804) includes transmitting the at least one verification inquiry to the one or more social network connections based at least partly on the at least one attempt to perform the at least one task via the at least one user device. For certain example implementations, at least one device (e.g., a server device 112) may transmit (e.g., send, convey, dispatch, propel onto or over the internet, propel onto or over a telecommunications network, transfer, broadcast, move down a protocol stack toward a transport layer, transmit wirelessly, transmit by wire, encapsulate in a transmission packet, encode for transmission, or a combination thereof, etc.) at least one verification inquiry 710 to one or more social network connections 714 based at least partly on at least one attempt to perform at least one task 706 via at least one user device 102. By way of example but not limitation, at least one server may transmit the at least one verification inquiry to the one or more social network connections based at least partly on the at least one attempt to perform the at least one task via the at least one user device (e.g., an Apple server may transmit using a proprietary iCloud communication channel or other communication capability a request for identity verification to Facebook friends based on a current user's attempt to purchase new skis with an iPhone). However, claimed subject matter is not limited to any particular described embodiments, implementations, examples, etc.

For certain example embodiments, an operation 912 may be directed at least partially to wherein the transmitting the at least one verification inquiry to the one or more social network connections based at least partly on the at least one attempt to perform the at least one task via the at least one user device (of operation 910) includes transmitting the at least one verification inquiry to the one or more social network connections using one or more email communications. For certain example implementations, at least one device (e.g., a server device 112) may transmit at least one verification inquiry 710 to one or more social network connections 714 using one or more email communications (e.g., email body, email subject line, email attachment, plain text email, hypertext markup language (HTML) email, email opened via communication program, email opened via browser, email opened via operating system (OS) feature, or a combination thereof, etc.). By way of example but not limitation, at least one server may transmit the at least one verification inquiry to the one or more social network connections using one or more email communications (e.g., a PayPal server may transmit to a MySpace member via email a request for confirmation that an owner of a Samsung Galaxy tablet is likely to be trying to purchase an expensive bicycle). However, claimed subject matter is not limited to any particular described embodiments, implementations, examples, etc.

For certain example embodiments, an operation 914 may be directed at least partially to wherein the transmitting the at least one verification inquiry to the one or more social network connections based at least partly on the at least one attempt to perform the at least one task via the at least one user device (of operation 910) includes transmitting the at least one verification inquiry to the one or more social network connections using one or more text message communications. For certain example implementations, at least one device (e.g., a server device 112) may transmit at least one verification inquiry 710 to one or more social network connections 714 using one or more text message communications (e.g., a text-based text message, a multi-media text message, a text message with a picture, a text message propagated over a telecommunications protocol, a text message propagated over an internet protocol, a text message propagated over a proprietary text messaging system, a text message propagated over an open text messaging system, or a combination thereof, etc.). By way of example but not limitation, at least one server may transmit the at least one verification inquiry to the one or more social network connections using one or more text message communications (e.g., a Google server as part of Google Wallet may send three respective verification inquiries as text messages to three respective smartphones of three respective Facebook friends of a Google Wallet account holder). However, claimed subject matter is not limited to any particular described embodiments, implementations, examples, etc.

For certain example embodiments, an operation 916 may be directed at least partially to wherein the transmitting the at least one verification inquiry to the one or more social network connections based at least partly on the at least one attempt to perform the at least one task via the at least one user device (of operation 910) includes transmitting the at least one verification inquiry to the one or more social network connections using one or more social-network-based communications. For certain example implementations, at least one device (e.g., a server device 112) may transmit at least one verification inquiry 710 to one or more social network connections 714 using one or more social-network-based communications (e.g., a communication that is effectuated at least partially using a social network app, a social network web site, a social network service, a server of a social network, or a combination thereof, etc.). By way of example but not limitation, at least one server may transmit the at least one verification inquiry to the one or more social network connections using one or more social-network-based communications (e.g., a Visa server may send two private Facebook messages, such as by using a Facebook account of a Visa cardholder being verified or a general Visa Security Facebook account, asking two Facebook friends if the Visa cardholder is likely to be staying at a four-star hotel in Brazil). However, claimed subject matter is not limited to any particular described embodiments, implementations, examples, etc.

For certain example embodiments, an operation 918 may be directed at least partially to wherein the transmitting the at least one verification inquiry to the one or more social network connections based at least partly on the at least one attempt to perform the at least one task via the at least one user device (of operation 910) includes obtaining contact information for the one or more social network connections from at least one social network. For certain example implementations, at least one device (e.g., a server device 112) may obtain contact information (e.g., a name, a phone number, an email address, an instant message identification, a handle, a social network alias, or a combination thereof, etc.) for one or more social network connections 714 from at least one social network 716. By way of example but not limitation, at least one server may obtain contact information for the one or more social network connections from at least one social network (e.g., a McAfee security server may retrieve from a Google+ account of a McAfee customer one or more pieces of communication-enabling-data, such as a Google+ identification, a phone number, or an email address, so as to enable the contacting of multiple Google+ members using credentials provided to McAfee by the McAfee customer). However, claimed subject matter is not limited to any particular described embodiments, implementations, examples, etc.

FIG. 9B illustrates a flow diagram 900B having example operations 922, 924, or 926. For certain example embodiments, an operation 922 may be directed at least partially to wherein the initiating transmission of at least one verification inquiry to one or more social network connections based at least partly on the at least one attempt to perform the at least one task via the at least one user device (of operation 804) includes requesting at least one social network to transmit the at least one verification inquiry to the one or more social network connections based at least partly on the at least one attempt to perform the at least one task via the at least one user device. For certain example implementations, at least one device (e.g., a server device 112) may request (e.g., ask, apply for, petition, send an instruction to, utilize a message-sending application programming interface (API) of, solicit, or a combination thereof, etc.) at least one social network 716 to transmit at least one verification inquiry 710 to one or more social network connections 714 based at least partly on at least one attempt to perform at least one task 706 via at least one user device 102. By way of example but not limitation, at least one server may request at least one social network to transmit the at least one verification inquiry to the one or more social network connections based at least partly on the at least one attempt to perform the at least one task via the at least one user device (e.g., a Visa server may send a request to Google+ asking Google to send a verification inquiry to an individual's parents via a Google+ message or via a Gmail email). However, claimed subject matter is not limited to any particular described embodiments, implementations, examples, etc.

For certain example embodiments, an operation 924 may be directed at least partially to wherein the requesting at least one social network to transmit the at least one verification inquiry to the one or more social network connections based at least partly on the at least one attempt to perform the at least one task via the at least one user device (of operation 922) includes identifying to the at least one social network the one or more social network connections. For certain example implementations, at least one device (e.g., a server device 112) may identify (e.g., provide, send, submit, or a combination thereof, etc. a proper name, an account name, an email address, a phone number, a social network alias, a reference or link, a unique label, or a combination thereof, etc.) to at least one social network 716 one or more social network connections 714. By way of example but not limitation, at least one server may identify to the at least one social network the one or more social network connections (e.g., an Apple server may list a spouse and a sibling to Facebook if requesting that Facebook send a verification inquiry to each of the spouse and the sibling regarding a purchase from Best Buy). However, claimed subject matter is not limited to any particular described embodiments, implementations, examples, etc.

For certain example embodiments, an operation 926 may be directed at least partially to wherein the requesting at least one social network to transmit the at least one verification inquiry to the one or more social network connections based at least partly on the at least one attempt to perform the at least one task via the at least one user device (of operation 922) includes identifying to the at least one social network at least one social network grouping that corresponds to the one or more social network connections. For certain example implementations, at least one device (e.g., a server device 112) may identify to at least one social network 716 at least one social network grouping (e.g., a set of social network members, a private or personal subset of social network members, a public or shared subset of social network members, a listing of social network members that are identifiable jointly, an amalgamation of social network members with an associated title or label that encompasses or connotes the members of the amalgamation, or a combination thereof, etc.) that corresponds to one or more social network connections 714. By way of example but not limitation, at least one server may identify to the at least one social network at least one social network grouping that corresponds to the one or more social network connections (e.g., a McAfee server may provide to Google+a name of a Google+Circle that includes a number of Google+ members that McAfee would like Google+ to send a verification inquiry to on behalf of a person that is both a McAfee customer and Google+ member). However, claimed subject matter is not limited to any particular described embodiments, implementations, examples, etc.

FIG. 9C illustrates a flow diagram 900C having example operations 930, 932, 934, or 936. For certain example embodiments, an operation 930 may be directed at least partially to wherein the requesting at least one social network to transmit the at least one verification inquiry to the one or more social network connections based at least partly on the at least one attempt to perform the at least one task via the at least one user device (of operation 922) includes requesting the at least one social network to send a private message including the at least one verification inquiry to the one or more social network connections based at least partly on the at least one attempt to perform the at least one task via the at least one user device. For certain example implementations, at least one device (e.g., a server device 112) may request at least one social network 716 to send a private message (e.g., a message that is not public, a message that is viewable by an intended recipient but not others, a message that can be accessed by a targeted social network account but not generally, a message that is not automatically forwarded to members that are part of an account's social graph, a message that is protected by an authentication procedure, a posting, a pinning, text, an image, video, or a combination thereof, etc.) including at least one verification inquiry 710 to one or more social network connections 714 based at least partly on at least one attempt to perform at least one task 706 via at least one user device 102. By way of example but not limitation, at least one server may request the at least one social network to send a private message including the at least one verification inquiry to the one or more social network connections based at least partly on the at least one attempt to perform the at least one task via the at least one user device (e.g., an Apple server may ask a Facebook server to send private Facebook messages to a couple of Facebook members who are Facebook friends of an Apple account holder who is attempting to purchase concert tickets to a Styx reunion tour using Apple's Passbook feature). However, claimed subject matter is not limited to any particular described embodiments, implementations, examples, etc.

For certain example embodiments, an operation 932 may be directed at least partially to wherein the requesting at least one social network to transmit the at least one verification inquiry to the one or more social network connections based at least partly on the at least one attempt to perform the at least one task via the at least one user device (of operation 922) includes providing to the at least one social network at least one characteristic indicative of the at least one task. For certain example implementations, at least one device (e.g., a server device 112) may provide (e.g., send at least a portion of, transmit at least a reference to, forward, submit via an API, or a combination thereof, etc.) to at least one social network 716 at least one characteristic (e.g., a fact, a description, a summary, an attribute, a synopsis, an explanation of where/when/how, a picture, or a combination thereof, etc.) indicative of (e.g., representative of, at least partially defining, explaining, describing, or a combination thereof, etc.) at least one task 706. By way of example but not limitation, at least one server may provide to the at least one social network at least one characteristic indicative of the at least one task (e.g., an Apple server may send a location of an iPhone that is to be used to complete a form over the internet and a code indicating that the task corresponds to changing a physical address). However, claimed subject matter is not limited to any particular described embodiments, implementations, examples, etc.

For certain example embodiments, an operation 934 may be directed at least partially to wherein the providing to the at least one social network at least one characteristic indicative of the at least one task (of operation 932) includes providing to the at least one social network at least one description of the at least one task. For certain example implementations, at least one device (e.g., a server device 112) may provide to at least one social network 716 at least one description (e.g., words explaining, an image representing, a link to an item, a URL to a webpage, a name of an application, a code or abbreviation for a task, or a combination thereof, etc.) of at least one task 706. By way of example but not limitation, at least one server may provide to the at least one social network at least one description of the at least one task (e.g., Google Wallet server functionality may send to Google+ server functionality an indication that a Google account holder is attempting to sign up for a bacon-of-the-month club). However, claimed subject matter is not limited to any particular described embodiments, implementations, examples, etc.

For certain example embodiments, an operation 936 may be directed at least partially to wherein the providing to the at least one social network at least one characteristic indicative of the at least one task (of operation 932) includes providing to the at least one social network at least one financial valuation associated with the at least one task. For certain example implementations, at least one device (e.g., a server device 112) may provide to at least one social network 716 at least one financial valuation (e.g., a dollar amount, a cost range, a listed price relating to, a discounted amount relating to, a payment plan, or a combination thereof, etc.) associated with (e.g., an amount to be incurred upon approval, an amount to be committed upon completion of, a likely amount to be charged, or a combination thereof, etc.) at least one task 706. By way of example but not limitation, at least one server may provide to the at least one social network at least one financial valuation associated with the at least one task (e.g., a server operated by or on behalf of Square payment systems may send to a Twitter server an indication that a transaction to be authorized is valued between $500-$1,000). However, claimed subject matter is not limited to any particular described embodiments, implementations, examples, etc.

FIG. 9D illustrates a flow diagram 900D having example operations 940, 942, 944, 946, or 948. For certain example embodiments, an operation 940 may be directed at least partially to wherein the initiating transmission of at least one verification inquiry to one or more social network connections based at least partly on the at least one attempt to perform the at least one task via the at least one user device (of operation 804) includes conditioning selection of the one or more social network connections based at least in part on one or more statuses of the one or more social network connections. For certain example implementations, at least one device (e.g., a server device 112) may condition selection (e.g., may impact selection, may be a factor if choosing, may be used to include, may be used to exclude, may be a precondition, may be a variable militating towards or away from using, or a combination thereof, etc.) of one or more social network connections 714 based at least in part on one or more statuses (e.g., a social network status, an instant message status, a phone status, a voice mail status, a calendar status, a calendar schedule, a status for open communication, a status for proprietary or vendor-specific communication, or a combination thereof, etc.) of one or more social network connections 714. By way of example but not limitation, at least one server may condition selection of the one or more social network connections based at least in part on one or more statuses of the one or more social network connections (e.g., a Google server may avoid sending verification inquiries to social network connections whose Google calendar schedules indicate that they are currently busy). However, claimed subject matter is not limited to any particular described embodiments, implementations, examples, etc.

For certain example embodiments, an operation 942 may be directed at least partially to wherein the conditioning selection of the one or more social network connections based at least in part on one or more statuses of the one or more social network connections (of operation 940) includes conditioning selection of the one or more social network connections based at least in part on one or more respective instant message statuses of respective ones of the one or more social network connections. For certain example implementations, at least one device (e.g., a server device 112) may condition selection of one or more social network connections 714 based at least in part on one or more respective instant message statuses (e.g., online, offline, away, invisible, available, taking messages, accepting emergency messages, accepting verification inquiries, not accepting verification inquiries, available by mobile device, at desktop, an instant message status for an open instant message system, an instant message status for a closed or proprietary instant message system, or a combination thereof, etc.) of respective ones of (e.g., corresponding to, associated with, matched with, linked to, or a combination thereof, etc.) one or more social network connections 714. By way of example but not limitation, at least one server may condition selection of the one or more social network connections based at least in part on one or more respective instant message statuses of respective ones of the one or more social network connections (e.g., an Apple server may select from a pool of social network connections those who have an available or non-busy status with respect to Apple's iMessage communication capability). However, claimed subject matter is not limited to any particular described embodiments, implementations, examples, etc.

For certain example embodiments, an operation 944 may be directed at least partially to wherein the initiating transmission of at least one verification inquiry to one or more social network connections based at least partly on the at least one attempt to perform the at least one task via the at least one user device (of operation 804) includes selecting the one or more social network connections to be sent the at least one verification inquiry based at least in part on at least one financial valuation associated with the at least one task. For certain example implementations, at least one device (e.g., a server device 112) may select (e.g., choose from between or among one or more of multiple ones, pick out from between or among one or more alternatives, designate, or a combination thereof, etc.) one or more social network connections 714 to be sent at least one verification inquiry 710 based at least in part on at least one financial valuation (e.g., a dollar amount, a cost range, a listed price relating to, a discounted amount relating to, a payment plan, or a combination thereof, etc.) associated with (e.g., an amount to be incurred upon approval, an amount to be committed upon completion of, a likely amount to be charged, or a combination thereof, etc.) at least one task 706. By way of example but not limitation, at least one server may select the one or more social network connections to be sent the at least one verification inquiry based at least in part on at least one financial valuation associated with the at least one task (e.g., a MasterCard server may select social network connections that are friends for confirming purchase of a meal with a smartphone but may select a social network connection that is a spouse or a parent for confirming purchase of a laptop with a smartphone). However, claimed subject matter is not limited to any particular described embodiments, implementations, examples, etc.

For certain example embodiments, an operation 946 may be directed at least partially to wherein the initiating transmission of at least one verification inquiry to one or more social network connections based at least partly on the at least one attempt to perform the at least one task via the at least one user device (of operation 804) includes selecting the one or more social network connections to be sent the at least one verification inquiry based at least in part on at least one nature of the at least one task. For certain example implementations, at least one device (e.g., a server device 112) may select (e.g., choose from between or among one or more of multiple ones, pick out from between or among one or more alternatives, designate, or a combination thereof, etc.) one or more social network connections 714 to be sent at least one verification inquiry 710 based at least in part on at least one nature (e.g., professional-related, personal-related, medical-related, work-related, communication-related, purchase-related, access-related, or a combination thereof, etc.) of at least one task 706. By way of example but not limitation, at least one server may select the one or more social network connections to be sent the at least one verification inquiry based at least in part on at least one nature of the at least one task (e.g., a TrendMicro server may select one or more LinkedIn social network connections that are co-workers if an attempted task includes accessing a work email account). However, claimed subject matter is not limited to any particular described embodiments, implementations, examples, etc.

For certain example embodiments, an operation 948 may be directed at least partially to wherein the initiating transmission of at least one verification inquiry to one or more social network connections based at least partly on the at least one attempt to perform the at least one task via the at least one user device (of operation 804) includes selecting the one or more social network connections to be sent the at least one verification inquiry based at least in part on at least one characteristic of one or more social network members. For certain example implementations, at least one device (e.g., a server device 112) may select (e.g., choose from between or among one or more of multiple ones, pick out from between or among one or more alternatives, designate, or a combination thereof, etc.) one or more social network connections 714 to be sent at least one verification inquiry 710 based at least in part on at least one characteristic (e.g., age, maternal or paternal relationship, spousal relationship, child relationship, hobbies, gender, social network interests such as likes or +1s, behavioral fingerprint, expertise, or a combination thereof, etc.) of one or more social network members (e.g., people who have a joined a social network, individuals having an account with a social network, or a combination thereof, etc.). By way of example but not limitation, at least one server may select the one or more social network connections to be sent the at least one verification inquiry based at least in part on at least one characteristic of one or more social network members (e.g., a Facebook server may avoid selecting a social network member for receipt of a verification inquiry for an attempted purchase within approximately 30 days of a likely gift-giving occurrence with respect to the social network member, such as within a month of a friend's birthday for a social network member who is a friend or within a month of Mother's Day for a social network member who is a mother of an authorized user of a device). However, claimed subject matter is not limited to any particular described embodiments, implementations, examples, etc.

FIG. 9E illustrates a flow diagram 900E having example operations 952, 954, or 956. For certain example embodiments, an operation 952 may be directed at least partially to wherein the initiating transmission of at least one verification inquiry to one or more social network connections based at least partly on the at least one attempt to perform the at least one task via the at least one user device (of operation 804) includes initiating transmission of the at least one verification inquiry to the one or more social network connections based at least partly on the at least one attempt, the at least one verification inquiry referencing an image of a current user of the at least one user device. For certain example implementations, at least one device (e.g., a server device 112) may initiate transmission 712 of at least one verification inquiry 710 to one or more social network connections 714 based at least partly on at least one attempt (to perform at least one task 706), with at least one verification inquiry 710 referencing (e.g., including in a body, including in an attachment, providing a link to, identifying, giving information enabling access or retrieval, or a combination thereof, etc.) an image (e.g., a still picture, a video, a snapshot, an image from a user device, an image from a proximate, other device 718, or a combination thereof, etc.) of a current user 104 of (e.g., a person operating, manipulating, holding, currently possessing, or a combination thereof, etc.) at least one user device 102. By way of example but not limitation, at least one server may initiate transmission of the at least one verification inquiry to the one or more social network connections based at least partly on the at least one attempt, the at least one verification inquiry referencing an image of a current user of the at least one user device (e.g., an Apple server may cause an image of a current user of an iPhone, which image results from a picture taken contemporaneously by a camera sensor of the iPhone, to be sent to two Twitter followers for confirmation that the current user is the owner or other known authorized user of the iPhone). However, claimed subject matter is not limited to any particular described embodiments, implementations, examples, etc.

For certain example embodiments, an operation 954 may be directed at least partially to wherein the initiating transmission of the at least one verification inquiry to the one or more social network connections based at least partly on the at least one attempt, the at least one verification inquiry referencing an image of a current user of the at least one user device, (of operation 952) includes initiating transmission of the at least one verification inquiry to the one or more social network connections based at least partly on the at least one attempt, the at least one verification inquiry referencing the image of the current user in a particular pose. For certain example implementations, at least one device (e.g., a server device 112) may initiate transmission 712 of at least one verification inquiry 710 to one or more social network connections 714 based at least partly on at least one attempt (to perform at least one task 706), with at least one verification inquiry 710 referencing an image of a current user 104 in a particular pose (e.g., a facial expression, an arm position, a hand sign, a finger location, a leg angle, a standing position, a direction angle of a camera acquiring an image, a location of a subject in an image frame, or a combination thereof, etc.). By way of example but not limitation, at least one server may initiate transmission of the at least one verification inquiry to the one or more social network connections based at least partly on the at least one attempt, the at least one verification inquiry referencing the image of the current user in a particular pose (e.g., a Square payment systems server may cause an image of a current user of a Microsoft surface tablet, with the current user having been asked to touch a ring finger to an opposite elbow for the picture, to be sent to three Facebook friends that are currently available via a mobile Facebook app and are being informed to look for the ring-finger-to-opposite-elbow pose). However, claimed subject matter is not limited to any particular described embodiments, implementations, examples, etc.

For certain example embodiments, an operation 956 may be directed at least partially to wherein the initiating transmission of the at least one verification inquiry to the one or more social network connections based at least partly on the at least one attempt, the at least one verification inquiry referencing the image of the current user in a particular pose, (of operation 954) includes initiating transmission of the at least one verification inquiry to the one or more social network connections based at least partly on the at least one attempt, the at least one verification inquiry referencing the image of the current user in the particular pose, with the particular pose designated by at least one social network connection of the one or more social network connections. For certain example implementations, at least one device (e.g., a server device 112) may initiate transmission 712 of at least one verification inquiry 710 to one or more social network connections 714 based at least partly on at least one attempt (to perform at least one task 706), with at least one verification inquiry 710 referencing an image of a current user 104 in a particular pose and with the particular pose designated by (e.g., described by, selected from a set of one or more choices by, requested by, previously designated, contemporaneously designated, agreed upon by, or a combination thereof, etc.) at least one social network connection of one or more social network connections 714. By way of example but not limitation, at least one server may initiate transmission of the at least one verification inquiry to the one or more social network connections based at least partly on the at least one attempt, the at least one verification inquiry referencing the image of the current user in the particular pose, with the particular pose designated by at least one social network connection of the one or more social network connections (e.g., a security company server may cause a link to a picture of a current user of a Motorola Droid smartphone, with the current user having been asked to wink closed a right eye and lean their head to the left for the picture, to be sent to two Google+ members that are in a verification circle of an authorized user of the Motorola Droid smartphone, wherein at least one of the two Google+ members indicated at least part of the pose, such as one designated the winking right eye and the other designated the left-leaning head in a verification-related exchange). However, claimed subject matter is not limited to any particular described embodiments, implementations, examples, etc.

FIG. 9F illustrates a flow diagram 900F having example operations 960, 962, 964, 966, 968, or 970. For certain example embodiments, an operation 960 may be directed at least partially to wherein the initiating transmission of at least one verification inquiry to one or more social network connections based at least partly on the at least one attempt to perform the at least one task via the at least one user device (of operation 804) includes asking the one or more social network connections to provide at least one confirmation. For certain example implementations, at least one device (e.g., a server device 112) may ask (e.g., request, petition, solicit, entreat, or a combination thereof, etc.) one or more social network connections 714 to provide (e.g., submit, return, send, signal, transmit, communicate, or a combination thereof, etc.) at least one confirmation (e.g., validation, refutation, truth establishment, genuineness reporting, positive confirmation, negative confirmation, correction, or a combination thereof, etc.). By way of example but not limitation, at least one server may ask the one or more social network connections to provide at least one confirmation (e.g., an American Express server may cause a verification inquiry to be transmitted to each of two Facebook friends with at least one of the two verification inquiries asking a Facebook friend recipient to validate something about a current user of an iPad tablet). However, claimed subject matter is not limited to any particular described embodiments, implementations, examples, etc.

For certain example embodiments, an operation 962 may be directed at least partially to wherein the asking the one or more social network connections to provide at least one confirmation (of operation 960) includes asking the one or more social network connections to provide at least one confirmation of identity of a current user of the at least one user device based at least partly on a presentation of at least one input from the current user. For certain example implementations, at least one device (e.g., a server device 112) may ask one or more social network connections 714 to provide at least one confirmation of identity (e.g., name, personhood, relationship, authorization status, an individual being described or indicated, or a combination thereof, etc.) of a current user 104 of (e.g., a person operating, manipulating, holding, currently possessing, or a combination thereof, etc.) at least one user device 102 based at least partly on a presentation (e.g., a display on a screen, an audible playing on a speaker, a visual playing of a video, a projection, or a combination thereof, etc.) of at least one input (e.g., an image, a textual response, a textual code word, a picture, a video, a spoken word or phrase, or a combination thereof, etc.) from current user 104. By way of example but not limitation, at least one server may ask the one or more social network connections to provide the at least one confirmation of identity of a current user of the at least one user device based at least partly on a presentation of at least one input from the current user (e.g., a Google server may ask a Google+ member for confirmation that a sound recording of a current user of an LG Android phone appears to match a voice of an authorized user of the LG Android phone). However, claimed subject matter is not limited to any particular described embodiments, implementations, examples, etc.

For certain example embodiments, an operation 964 may be directed at least partially to wherein the asking the one or more social network connections to provide at least one confirmation (of operation 960) includes asking the one or more social network connections to provide at least one confirmation that a current position of the at least one user device is a likely location of an authorized user of the at least one user device. For certain example implementations, at least one device (e.g., a server device 112) may ask one or more social network connections 714 to provide at least one confirmation that a current position (e.g., an address, a city, a store, a person's house, a business's establishment, map coordinates, a map location, or a combination thereof, etc.) of at least one user device 102 is a likely (e.g., probable, expected, unsurprising, precedented, predictable, or a combination thereof, etc.) location of an authorized user (e.g., an owner, an approved borrower, a purchaser, a primary user, an individual designated to be authorized by an owner, a person who legitimately possesses authentication credentials, or a combination thereof, etc.) of at least one user device 102. By way of example but not limitation, at least one server may ask the one or more social network connections to provide the at least one confirmation that a current position of the at least one user device is a likely location of an authorized user of the at least one user device (e.g., a Kaspersky server may prompt Facebook to ask three Facebook friends of an authorized user if the authorized user, or a Nokia Lumia smartphone owned by the authorized user, is likely to be in Singapore). However, claimed subject matter is not limited to any particular described embodiments, implementations, examples, etc.

For certain example embodiments, an operation 966 may be directed at least partially to wherein the asking the one or more social network connections to provide at least one confirmation (of operation 960) includes asking the one or more social network connections to provide at least one confirmation that the at least one task is a task that is likely to be performed by an authorized user of the at least one user device. For certain example implementations, at least one device (e.g., a server device 112) may ask one or more social network connections 714 to provide at least one confirmation that at least one task 706 is a task that is likely (e.g., probable, expected, unsurprising, precedented, predictable, or a combination thereof, etc.) to be performed by an authorized user (e.g., an owner, an approved borrower, a purchaser, a primary user, an individual designated to be authorized by an owner, a person who legitimately possesses authentication credentials, or a combination thereof, etc.) of at least one user device 102. By way of example but not limitation, at least one server may ask the one or more social network connections to provide the at least one confirmation that the at least one task is a task that is likely to be performed by an authorized user of the at least one user device (e.g., a Visa server may send, as part of a verification inquiry, an indication that an HTC Windows Phone 8 is in the process of attempting to be used to purchase an engagement ring to four LinkedIn connections that an authorized user of the HTC Windows Phone 8 frequently interacts with asking if the authorized user is likely to be in the market for an engagement ring). However, claimed subject matter is not limited to any particular described embodiments, implementations, examples, etc.

For certain example embodiments, an operation 968 may be directed at least partially to wherein the asking the one or more social network connections to provide at least one confirmation (of operation 960) includes asking the one or more social network connections to provide at least one confirmation that there is no possession of knowledge of the at least one user device being missing. For certain example implementations, at least one device (e.g., a server device 112) may ask one or more social network connections 714 to provide at least one confirmation that there is no possession of knowledge of (e.g., not been told by an authorized user, not been informed generally, not noticed a social network update regarding, not heard a rumor about, or a combination thereof, etc.) of at least one user device 102 being missing (e.g., lost, stolen, misplaced, of unknown whereabouts, not locatable via a GPS/Wi-Fi positioning feature, or a combination thereof, etc.). By way of example but not limitation, at least one server may ask the one or more social network connections to provide the at least one confirmation that there is no possession of knowledge of the at least one user device being missing (e.g., a Microsoft server may ask three adult children to confirm that they have not been informed that their elderly father cannot find his Microsoft Surface Windows Phone 8). However, claimed subject matter is not limited to any particular described embodiments, implementations, examples, etc.

For certain example embodiments, an operation 970 may be directed at least partially to wherein the asking the one or more social network connections to provide at least one confirmation (of operation 960) includes asking the one or more social network connections to provide at least one confirmation that a recent communication with at least one authorized user of the at least one user device had been experienced. For certain example implementations, at least one device (e.g., a server device 112) may ask one or more social network connections 714 to provide at least one confirmation that a recent (e.g., last 24 hours, last 5 minutes, current month, sufficiently close in time to provide an indicium of reliability of continuing possession, that morning, last half hour, or a combination thereof, etc.) communication (e.g., phone call, email, text message, social network posting, social network private message, instant message, or a combination thereof, etc.) with at least one authorized user (e.g., e.g., an owner, an approved borrower, a purchaser, a primary user, an individual designated to be authorized by an owner, a person who legitimately possesses authentication credentials, or a combination thereof, etc.) of at least one user device 102 had been experienced (e.g., bi-directional talking, read, listened to, received, viewed, heard, interactive discussion via speech or writing, or a combination thereof, etc.). By way of example but not limitation, at least one server may ask the one or more social network connections to provide the at least one confirmation that a recent communication with at least one authorized user of the at least one user device had been experienced (e.g., an Apple server may ask a Facebook friend of an owner of an iPhone 5 if the Facebook friend has participated in a phone call with the owner of the iPhone 5 in the last 2 hours). However, claimed subject matter is not limited to any particular described embodiments, implementations, examples, etc.

FIGS. 10A-10C depict example additions or alternatives for a flow diagram of FIG. 8A in accordance with certain example embodiments. As illustrated, flow diagrams of FIGS. 10A-10C may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 10A-10C may be performed so as to be fully or partially overlapping with other operation(s). For certain example embodiments, one or more operations of flow diagrams 1000A-1000C (of FIGS. 10A-10C) may be performed by at least one server device (e.g., a server device 112). Alternatively, one or more operations of flow diagrams 1000A-1000C may be performed by at least one user device (e.g., a user device 102).

FIG. 10A illustrates a flow diagram 1000A having example operations 806, 1010a, or 1010b. For certain example embodiments, an operation 806 may be directed at least partially to wherein a method further includes implementing one or more additional operations. For certain example implementations, at least one device (e.g., a server device 112) may implement one or more operations in addition to a detecting (of operation 802) and an initiating transmission (of operation 804). Example additional operations may include, by way of example but not limitation, 1010a, 1010b, 1014, 1016, 1018, 1022, or 1024.

For certain example embodiments, an operation 1010a and 1010b may be directed at least partially to wherein a method of detecting (of operation 802) and initiating transmission (of operation 804) further includes: receiving at least one response for the at least one verification inquiry from the one or more social network connections (for operation 1010a) and determining if performance of the at least one task is to be authorized based at least in part on the at least one response for the at least one verification inquiry (for operation 1010b). For certain example implementations, at least one device (e.g., a server device 112): may further receive (e.g., accept a signal having, accept possession, detect delivery, decode, receive wirelessly, receive by wire, or a combination thereof, etc.) at least one response (e.g., an email, a text message, an instant message, a proprietary communication, a signal, a communication packet, a spoken word, a keypad press, a message from an app, or a combination thereof, etc.) for at least one verification inquiry 710 from one or more social network connections 714 or may further determine (e.g., ascertain, decide, conclude, or a combination thereof, etc.) if performance of at least one task 706 is to be authorized (e.g., approved, allowed to continue, permitted to conclude, sanctioned, or a combination thereof, etc.) based at least in part on the at least one response for the at least one verification inquiry 710. By way of example but not limitation, at least one server: may further receive at least one response for the at least one verification inquiry from the one or more social network connections (e.g., a Visa server may receive a telephonic verbal or keypad confirmation from a social network member that a Visa account holder is likely to want to fly to Greece) or may further determine if performance of the at least one task is to be authorized based at least in part on the at least one response for the at least one verification inquiry (e.g., a Visa server may determine if an airline flight purchase is going to be approved based at least partially on a telephonic confirmation from a social network member that a Visa account holder is likely to want to fly to Greece). However, claimed subject matter is not limited to any particular described embodiments, implementations, examples, etc.

FIG. 10B illustrates a flow diagram 1000B having example operations 1014, 1016, or 1018. For certain example embodiments, an operation 1014 may be directed at least partially to wherein a method of detecting (of operation 802) and initiating transmission (of operation 804) further includes receiving at least one response for the at least one verification inquiry from the one or more social network connections. For certain example implementations, at least one device (e.g., a server device 112) may further receive (e.g., accept a signal having, accept possession of, detect delivery of, decode, receive wirelessly, receive by wire, or a combination thereof, etc.) at least one response (e.g., an email, a text message, an instant message, a proprietary communication, a signal, a communication packet, a spoken word, a keypad press, a message from an app, or a combination thereof, etc.) for at least one verification inquiry 710 from one or more social network connections 714. By way of example but not limitation, at least one server may further receive at least one response for the at least one verification inquiry from the one or more social network connections (e.g., a Google+ server may receive from a social network member a text message refuting that an image of a current user of a Samsung Galaxy smartphone corresponds to an authorized user of the Samsung Galaxy smartphone). However, claimed subject matter is not limited to any particular described embodiments, implementations, examples, etc.

For certain example embodiments, an operation 1016 may be directed at least partially to wherein the receiving at least one response for the at least one verification inquiry from the one or more social network connections (of operation 1014) includes making an authentication decision with respect to the at least one user device or a current user of the at least one user device based at least partly on the at least one response and at least one behavioral fingerprint that is associated with the at least one user device. For certain example implementations, at least one device (e.g., a server device 112) may make an authentication decision (e.g., a determination, judgment, appraisal, analysis, or a combination thereof, etc. as to whether a person, individual, entity, or a combination thereof, etc. comprises who or what it is purported to be in terms of name, identity, rights, label, account holder, associated account, or a combination thereof, etc.) with respect to at least one user device 102 or a current user 104 (e.g., a person operating, manipulating, holding, currently possessing, or a combination thereof, etc. at least one user device) of at least one user device 102 based at least partly on at least one response (e.g., an email, a text message, an instant message, a proprietary communication, a signal, a communication packet, a spoken word, a keypad press, a message from an app, or a combination thereof, etc.) and at least one behavioral fingerprint 110 that is associated with (e.g., tied to, capable of affecting operation of, updated with behavioral indications reflecting interactions with, corresponding to, or a combination thereof, etc.) at least one user device 102. By way of example but not limitation, at least one server may make an authentication decision with respect to the at least one user device or a current user of the at least one user device based at least partly on the at least one response and at least one behavioral fingerprint that is associated with the at least one user device (e.g., an Apple server may determine that a current user of an iPhone is an authentic authorized user of the iPhone with regard to a furniture purchase in Albany, N.Y. based at least partially on confirmation from a social network member that there has been a recent communication with the authorized user via the iPhone in conjunction with an analysis using a behavioral fingerprint that is associated with the iPhone, which analysis indicates that the authorized user has just sent a child to college in Albany, N.Y.). However, claimed subject matter is not limited to any particular described embodiments, implementations, examples, etc.

For certain example embodiments, an operation 1018 may be directed at least partially to wherein the receiving at least one response for the at least one verification inquiry from the one or more social network connections (of operation 1014) includes incorporating the at least one response for the at least one verification inquiry into at least one behavioral fingerprint that is associated with the at least one user device. For certain example implementations, at least one device (e.g., a server device 112) may incorporate (e.g., include, add, consider, apply, make use of, factor into, account for, update responsive to, supplement with, make an adjustment based on, or a combination thereof, etc.) at least one response (e.g., an email, a text message, an instant message, a proprietary communication, a signal, a communication packet, a spoken word, a keypad press, a message from an app, or a combination thereof, etc.) for at least one verification inquiry 710 into at least one behavioral fingerprint 110 that is associated with (e.g., tied to, capable of affecting operation of, updated with behavioral indications reflecting interactions with, corresponding to, a combination thereof, etc.) at least one user device 102. By way of example but not limitation, at least one server may incorporate the at least one response for the at least one verification inquiry into at least one behavioral fingerprint that is associated with the at least one user device (e.g., a Google server may add an indication to a behavioral fingerprint associated with an Asus Android tablet that an authorized user thereof is likely to be buying skiing-related items, such as lift tickets or ski pants or hotel reservations in a ski resort area, if a response from a social network member confirms that the authorized user is likely to be buying skis). However, claimed subject matter is not limited to any particular described embodiments, implementations, examples, etc.

FIG. 10C illustrates a flow diagram 1000C having example operations 1022 or 1024. For certain example embodiments, an operation 1022 may be directed at least partially to wherein the receiving at least one response for the at least one verification inquiry from the one or more social network connections (of operation 1014) includes making an authentication decision with respect to the at least one user device or a current user of the at least one user device based at least partly on a number of received confirming responses. For certain example implementations, at least one device (e.g., a server device 112) may make an authentication decision (e.g., a determination, judgment, appraisal, analysis, or a combination thereof, etc. as to whether a person, individual, entity, or a combination thereof, etc. comprises who or what it is purported to be in terms of name, identity, rights, label, account holder, associated account, or a combination thereof, etc.) with respect to at least one user device 102 or a current user 104 (e.g., a person operating, manipulating, holding, currently possessing, or a combination thereof, etc. at least one user device) of at least one user device 102 based at least partly on a number (e.g., a minimum total number, a number within a particular period of time, one number of first tier network connections or another, greater number of second tier network connections, or a combination thereof, etc.) of received confirming responses (e.g., responses that affirm identity, responses that agree with an assertion, responses that do not refute a conclusion, responses that coincide with an expected answer, responses that support a likelihood of a task being desired by an authorized user, or a combination thereof, etc.). By way of example but not limitation, at least one server may make an authentication decision with respect to the at least one user device or a current user of the at least one user device based at least partly on a number of received confirming responses (e.g., a Bank of America server may decide whether a current user of an Apple iPhone is authentic based at least partially on whether or not at least three Facebook friends confirm that an authorized user of the iPhone had indicated to them that the authorized user was planning to buy a car soon). However, claimed subject matter is not limited to any particular described embodiments, implementations, examples, etc.

For certain example embodiments, an operation 1024 may be directed at least partially to wherein the receiving at least one response for the at least one verification inquiry from the one or more social network connections (of operation 1014) includes making an authentication decision with respect to the at least one user device or a current user of the at least one user device based at least partly on at least one certainty level of the at least one response. For certain example implementations, at least one device (e.g., a server device 112) may make an authentication decision (e.g., a determination, judgment, appraisal, analysis, or a combination thereof, etc. as to whether a person, individual, entity, or a combination thereof, etc. comprises who or what it is purported to be in terms of name, identity, rights, label, account holder, associated account, or a combination thereof, etc.) with respect to at least one user device 102 or a current user 104 (e.g., a person operating, manipulating, holding, currently possessing, or a combination thereof, etc. at least one user device) of at least one user device 102 based at least partly on at least one certainty level (e.g., a confidence level, a likely accuracy, an indication of expected correctness strength, a numerical value, a number of stars, or a combination thereof, etc.) of at least one response (e.g., an email, a text message, an instant message, a proprietary communication, a signal, a communication packet, a spoken word, a keypad press, a message from an app, or a combination thereof, etc.). By way of example but not limitation, at least one server may make an authentication decision with respect to the at least one user device or a current user of the at least one user device based at least partly on at least one certainty level of the at least one response (e.g., a Google server may decide whether a current user of a Nexus smartphone is the owner thereof based at least partially on whether an average certainty level of four out of a possible five is returned from confirmation response(s) received from at least one Google+ member). However, claimed subject matter is not limited to any particular described embodiments, implementations, examples, etc.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Modules, logic, circuitry, hardware and software combinations, firmware, or so forth may be realized or implemented as one or more general-purpose processors, one or more processing cores, one or more special-purpose processors, one or more microprocessors, at least one Application-Specific Integrated Circuit (ASIC), at least one Field Programmable Gate Array (FPGA), at least one digital signal processor (DSP), some combination thereof, or so forth that is executing or is configured to execute instructions, a special-purpose program, an application, software, code, some combination thereof, or so forth as at least one special-purpose computing apparatus or specific computing component. One or more modules, logic, or circuitry, etc. may, by way of example but not limitation, be implemented using one processor or multiple processors that are configured to execute instructions (e.g., sequentially, in parallel, at least partially overlapping in a time-multiplexed fashion, at least partially overlapping across multiple cores, or a combination thereof, etc.) to perform a method or realize a particular computing machine. For example, a first module may be embodied by a given processor executing a first set of instructions at or during a first time, and a second module may be embodied by the same given processor executing a second set of instructions at or during a second time. Moreover, the first and second times may be at least partially interleaved or overlapping, such as in a multi-threading, pipelined, or predictive processing environment. As an alternative example, a first module may be embodied by a first processor executing a first set of instructions, and a second module may be embodied by a second processor executing a second set of instructions. As another alternative example, a particular module may be embodied partially by a first processor executing at least a portion of a particular set of instructions and embodied partially by a second processor executing at least a portion of the particular set of instructions. Other combinations of instructions, a program, an application, software, or code, etc. in conjunction with at least one processor or other execution machinery may be utilized to realize one or more modules, logic, or circuitry, etc. to implement any of the processing algorithms described herein.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

This application may make reference to one or more trademarks, e.g., a word, letter, symbol, or device adopted by one manufacturer or merchant and used to identify and distinguish his or her product from those of others. Trademark names used herein are set forth in such language that makes clear their identity, that distinguishes them from common descriptive nouns, that have fixed and definite meanings, and, in many if not all cases, are accompanied by other specific identification using terms not covered by trademark. In addition, trademark names used herein have meanings that are well-known and defined in the literature, and do not refer to products or compounds protected by trade secrets in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or [trade], even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for behavioral fingerprinting via social network verification, the method being at least partially implemented by a device, the method comprising:
detecting at least one attempt to perform at least one task via at least one user device; and
initiating transmission of at least one verification inquiry to one or more social network connections based at least partly on the at least one attempt to perform the at least one task via the at least one user device.

2. The method of claim 1, wherein the detecting at least one attempt to perform at least one task via at least one user device comprises:
detecting the at least one attempt by a current user to perform the at least one task via the at least one user device.

3. The method of claim 2, wherein the detecting the at least one attempt by a current user to perform the at least one task via the at least one user device comprises:
detecting the at least one attempt by the current user to make a purchase via the at least one user device.

4. The method of claim 2, wherein the detecting the at least one attempt by a current user to perform the at least one task via the at least one user device comprises:
detecting the at least one attempt by the current user to access a program via the at least one user device.

5. The method of claim 1, wherein the detecting at least one attempt to perform at least one task via at least one user device comprises:
detecting the at least one attempt to perform the at least one task via at least one mobile phone.

6. The method of claim 1, wherein the detecting at least one attempt to perform at least one task via at least one user device comprises:
detecting the at least one attempt to perform the at least one task via at least one tablet computer.

7. The method of claim 1, wherein the detecting at least one attempt to perform at least one task via at least one user device comprises:
detecting the at least one attempt by an automatic function of the at least one user device to perform the at least one task via the at least one user device.

8. The method of claim 1, wherein the detecting at least one attempt to perform at least one task via at least one user device comprises:
detecting the at least one attempt by an agent to perform the at least one task via the at least one user device.

9. The method of claim 1, wherein the detecting at least one attempt to perform at least one task via at least one user device comprises:
detecting the at least one attempt to perform at least one privileged task via the at least one user device.

10. The method of claim 9, wherein the detecting the at least one attempt to perform at least one privileged task via the at least one user device comprises:
detecting the at least one attempt to perform the at least one privileged task via the at least one user device, with the at least one privileged task having a performance permission that is conditioned at least partially on at least one affirmative authentication procedure.

11. The method of claim 10, wherein the detecting the at least one attempt to perform the at least one privileged task via the at least one user device, with the at least one privileged task having a performance permission that is conditioned at least partially on at least one affirmative authentication procedure comprises:
detecting the at least one attempt to perform the at least one privileged task via the at least one user device, with the at least one privileged task having the performance permission that is conditioned at least partially on at least one submission of one or more memory-based inputs.

12. The method of claim 10, wherein the detecting the at least one attempt to perform the at least one privileged task via the at least one user device, with the at least one privileged task having a performance permission that is conditioned at least partially on at least one affirmative authentication procedure comprises:
detecting the at least one attempt to perform the at least one privileged task via the at least one user device, with the at least one privileged task having the performance permission that is conditioned at least partially on at least one provision of one or more biometric-based inputs.

13. The method of claim 1, wherein the initiating transmission of at least one verification inquiry to one or more social network connections based at least partly on the at least one attempt to perform the at least one task via the at least one user device comprises:
transmitting the at least one verification inquiry to the one or more social network connections based at least partly on the at least one attempt to perform the at least one task via the at least one user device.

14. The method of claim 13, wherein the transmitting the at least one verification inquiry to the one or more social network connections based at least partly on the at least one attempt to perform the at least one task via the at least one user device comprises:
transmitting the at least one verification inquiry to the one or more social network connections using one or more email communications.

15. The method of claim 13, wherein the transmitting the at least one verification inquiry to the one or more social network connections based at least partly on the at least one attempt to perform the at least one task via the at least one user device comprises:
transmitting the at least one verification inquiry to the one or more social network connections using one or more text message communications.

16. The method of claim 13, wherein the transmitting the at least one verification inquiry to the one or more social network connections based at least partly on the at least one attempt to perform the at least one task via the at least one user device comprises:
transmitting the at least one verification inquiry to the one or more social network connections using one or more social-network-based communications.

17. The method of claim 13, wherein the transmitting the at least one verification inquiry to the one or more social network connections based at least partly on the at least one attempt to perform the at least one task via the at least one user device comprises:
obtaining contact information for the one or more social network connections from at least one social network.

18. The method of claim 1, wherein the initiating transmission of at least one verification inquiry to one or more social network connections based at least partly on the at least one attempt to perform the at least one task via the at least one user device comprises:
requesting at least one social network to transmit the at least one verification inquiry to the one or more social network connections based at least partly on the at least one attempt to perform the at least one task via the at least one user device.

19. The method of claim 18, wherein the requesting at least one social network to transmit the at least one verification inquiry to the one or more social network connections based at least partly on the at least one attempt to perform the at least one task via the at least one user device comprises:
identifying to the at least one social network the one or more social network connections.

20. The method of claim 18, wherein the requesting at least one social network to transmit the at least one verification inquiry to the one or more social network connections based at least partly on the at least one attempt to perform the at least one task via the at least one user device comprises:
identifying to the at least one social network at least one social network grouping that corresponds to the one or more social network connections.

21. The method of claim 18, wherein the requesting at least one social network to transmit the at least one verification inquiry to the one or more social network connections based at least partly on the at least one attempt to perform the at least one task via the at least one user device comprises:
requesting the at least one social network to send a private message including the at least one verification inquiry to the one or more social network connections based at least partly on the at least one attempt to perform the at least one task via the at least one user device.

22. The method of claim 18, wherein the requesting at least one social network to transmit the at least one verification inquiry to the one or more social network connections based at least partly on the at least one attempt to perform the at least one task via the at least one user device comprises:
providing to the at least one social network at least one characteristic indicative of the at least one task.

23. (canceled)

24. (canceled)

25. The method of claim 1, wherein the initiating transmission of at least one verification inquiry to one or more social network connections based at least partly on the at least one attempt to perform the at least one task via the at least one user device comprises:
conditioning selection of the one or more social network connections based at least in part on one or more statuses of the one or more social network connections.

26. The method of claim 25, wherein the conditioning selection of the one or more social network connections based at least in part on one or more statuses of the one or more social network connections comprises:
conditioning selection of the one or more social network connections based at least in part on one or more respective instant message statuses of respective ones of the one or more social network connections.

27. The method of claim 1, wherein the initiating transmission of at least one verification inquiry to one or more social network connections based at least partly on the at least one attempt to perform the at least one task via the at least one user device comprises:
selecting the one or more social network connections to be sent the at least one verification inquiry based at least in part on at least one financial valuation associated with the at least one task.

28. The method of claim 1, wherein the initiating transmission of at least one verification inquiry to one or more social network connections based at least partly on the at least one attempt to perform the at least one task via the at least one user device comprises:
selecting the one or more social network connections to be sent the at least one verification inquiry based at least in part on at least one nature of the at least one task.

29. The method of claim 1, wherein the initiating transmission of at least one verification inquiry to one or more social network connections based at least partly on the at least one attempt to perform the at least one task via the at least one user device comprises:
selecting the one or more social network connections to be sent the at least one verification inquiry based at least in part on at least one characteristic of one or more social network members.

30. The method of claim 1, wherein the initiating transmission of at least one verification inquiry to one or more social network connections based at least partly on the at least one attempt to perform the at least one task via the at least one user device comprises:
initiating transmission of the at least one verification inquiry to the one or more social network connections based at least partly on the at least one attempt, the at least one verification inquiry referencing an image of a current user of the at least one user device.

31. The method of claim 30, wherein the initiating transmission of the at least one verification inquiry to the one or more social network connections based at least partly on the at least one attempt, the at least one verification inquiry referencing an image of a current user of the at least one user device, comprises:
initiating transmission of the at least one verification inquiry to the one or more social network connections based at least partly on the at least one attempt, the at least one verification inquiry referencing the image of the current user in a particular pose.

32. (canceled)

33. The method of claim 1, wherein the initiating transmission of at least one verification inquiry to one or more social network connections based at least partly on the at least one attempt to perform the at least one task via the at least one user device comprises:
asking the one or more social network connections to provide at least one confirmation.

34. The method of claim 33, wherein the asking the one or more social network connections to provide at least one confirmation comprises:
asking the one or more social network connections to provide at least one confirmation of identity of a current user of the at least one user device based at least partly on a presentation of at least one input from the current user.

35. The method of claim 33, wherein the asking the one or more social network connections to provide at least one confirmation comprises:
asking the one or more social network connections to provide at least one confirmation that a current position of the at least one user device is a likely location of an authorized user of the at least one user device.

36. The method of claim 33, wherein the asking the one or more social network connections to provide at least one confirmation comprises:
asking the one or more social network connections to provide at least one confirmation that the at least one task is a task that is likely to be performed by an authorized user of the at least one user device.

37. The method of claim 33, wherein the asking the one or more social network connections to provide at least one confirmation comprises:
asking the one or more social network connections to provide at least one confirmation that there is no possession of knowledge of the at least one user device being missing.

38. The method of claim 33, wherein the asking the one or more social network connections to provide at least one confirmation comprises:
asking the one or more social network connections to provide at least one confirmation that a recent communication with at least one authorized user of the at least one user device had been experienced.

39. The method of claim 1, further comprising:
receiving at least one response for the at least one verification inquiry from the one or more social network connections; and
determining if performance of the at least one task is to be authorized based at least in part on the at least one response for the at least one verification inquiry.

40. The method of claim 1, further comprising:
receiving at least one response for the at least one verification inquiry from the one or more social network connections.

41.-44. (canceled)

45. A system for behavioral fingerprinting via social network verification, the system comprising:
circuitry for detecting at least one attempt to perform at least one task via at least one user device; and
circuitry for initiating transmission of at least one verification inquiry to one or more social network connections based at least partly on the at least one attempt to perform the at least one task via the at least one user device.

46.-88. (canceled)

89. A system for behavioral fingerprinting via social network verification, the system comprising:
means for detecting at least one attempt to perform at least one task via at least one user device; and
means for initiating transmission of at least one verification inquiry to one or more social network connections based at least partly on the at least one attempt to perform the at least one task via the at least one user device.

90.-132. (canceled)
